(19) United States
(12) Patent Application Publication
(10) Pub. No.: US 2025/0389949 A1
(43) Pub. Date: Dec. 25, 2025

(54) OPTICAL DEVICE

(71) Applicant: Panasonic Intellectual Property Management Co., Ltd., Osaka (JP)

(72) Inventors: KAZUKI NAKAMURA, Osaka (JP); TAKAIKI NOMURA, Osaka (JP); YASUHISA INADA, Osaka (JP)

(21) Appl. No.: 19/315,783

(22) Filed: Sep. 1, 2025

Related U.S. Application Data
(63) Continuation of application No. PCT/JP2023/045579, filed on Dec. 19, 2023.

(30) Foreign Application Priority Data
Mar. 15, 2023 (JP) 2023-040420

(51) Int. Cl. G02B 26/06; G02B 17/00

(52) U.S. Cl. CPC G02B 26/06; G02B 17/006; G02B 17/008

(57) ABSTRACT

An optical device includes a first mirror; a second mirror; an adjustment layer that is positioned between the first mirror and the second mirror, and whose refractive index or thickness is adjustable; and an optical waveguide through which light propagates along a predetermined direction and that includes a portion that is positioned between the first mirror and the second mirror. The optical waveguide includes, at the portion that is positioned between the first mirror and the second mirror, a first region, a second region, and a third region. The first region includes one or more gratings whose refractive index periodically changes along the predetermined direction. The second region and the third region do not include a grating. In top view, the first region, the second region, and the third region overlap all of the first mirror, the second mirror, and the adjustment layer.

### BACKGROUND

### 1. Technical Field

The present disclosure relates to an optical device.

### 2. Description of the Related Art

Hitherto, various devices that can scan a space with light have been proposed.

International Publication No. 2013/168266 discloses a structure that can perform scanning with light by using a driving device that rotates a mirror.

Japanese Unexamined Patent Application Publication (Translation of PCT Application) No. 2016-508235 discloses an optical phased array including a plurality of nanophotonic antenna elements that are two-dimensionally arranged. Each antenna element is optically coupled to a variable optical delay line (that is, a phase shifter). In the optical phased array, a coherent light beam is guided to each antenna element by a waveguide, and the phase of the light beam is shifted by the phase shifter. This makes it possible to change an amplitude distribution of a far field radiation pattern.

Japanese Unexamined Patent Application Publication No. 2013-16591 discloses a light deflection element including a waveguide, a light entrance opening, and a light exit opening, the waveguide including an optical waveguide layer in which light is guided and a first distributed Bragg reflector that is formed at an upper surface and a lower surface of the optical waveguide layer, the light entrance opening being provided for allowing light to enter the inside of the waveguide, the light exit opening being provided at a surface of the waveguide for allowing the light that enters through the light entrance opening and that is guided in the waveguide to exit.

### SUMMARY

One non-limiting and exemplary embodiment provides an optical device that is easy to manufacture and that can perform scanning with light.

In one general aspect, the techniques disclosed here feature an optical device including: a first mirror; a second mirror that is disposed to face the first mirror; an adjustment layer that is positioned between the first mirror and the second mirror, and whose refractive index or thickness is adjustable; and an optical waveguide through which light propagates along a predetermined direction and that includes a portion that is positioned between the first mirror and the second mirror, wherein the optical waveguide includes, at the portion that is positioned between the first mirror and the second mirror, a first region, a second region that is positioned on a side opposite to a light input side of the first region, and a third region that is positioned on a side opposite to the second region with the first region being interposed between the second region and the third region, wherein the first region includes one or more gratings whose refractive index periodically changes along the predetermined direction, wherein the second region and the third region do not include a grating, and wherein, in top view, the first region, the second region, and the third region overlap all of the first mirror, the second mirror, and the adjustment layer.

According to the one aspect of the present disclosure, it is possible to realize an optical device that is easy to manufacture and that can perform scanning with light.

Comprehensive or specific embodiments of the present disclosure may be implemented by a system, a device, a method, an integrated circuit, a computer program, or a recording medium, such as a computer-readable recording disk, or may be implemented by any combination of the system, the device, the method, the integrated circuit, the computer program, and the recording medium. The computer-readable recording medium may include, for example, a non-volatile recording medium, such as CD-ROM (Compact Disc-Read Only Memory). The device may include one or more devices. When the device includes two or more devices, the two or more devices may be disposed in one apparatus, or may be separately disposed in two or more separated apparatuses. In the present description and the claims, “device” may mean not only one device, but also a system including a plurality of devices.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view schematically showing a structure of an optical scanning device;

FIG. 2 is a schematic view of an example of a cross-sectional structure of one waveguide element and propagation of light;

FIG. 3A is a cross-sectional view of a waveguide array from which light exits in a direction perpendicular to an exit surface of the waveguide array;

FIG. 3B is a cross-sectional view of the waveguide array from which light exits in a direction differing from the direction perpendicular to the exit surface of the waveguide array;

FIG. 4 is a perspective view schematically showing a waveguide array in three-dimensional space;

FIG. 5 is a schematic view of a waveguide array and a phase shifter array as seen from a normal direction to a light exit surface (a Z direction);

FIG. 6 is a cross-sectional view parallel to an XZ plane, schematically showing a structure of an optical device according to a comparative example;

FIG. 7A is a cross-sectional view parallel to an XZ plane, schematically showing a structure of an optical device according to an exemplary embodiment of the present disclosure;

FIG. 7B is a cross-sectional view parallel to a YZ plane, schematically showing a structure of the optical device according to the exemplary embodiment of the present disclosure;

FIG. 7C is a cross-sectional view parallel to an XY plane of a layer including optical waveguides in the optical device shown in FIGS. 7A and 7B;

FIG. 7D is a top view schematically showing a lower-portion structural body before affixing thereto an upper-portion structural body in the optical device shown in FIGS. 7A and 7B;

FIG. 8A is a graph showing the relationship between a gap length between upper and lower mirrors and an exit angle of light that exits from the upper mirror;

FIG. 8B is another graph showing the relationship between the gap length between the upper and lower mirrors and the exist angle of light that exits from the upper mirror;

FIG. 9A is a cross-sectional view parallel to an XZ plane, schematically showing Modification 1 of the optical device according to the present embodiment;

FIG. 9B is a cross-sectional view parallel to an XZ plane, schematically showing Modification 2 of the optical device according to the present embodiment;

FIG. 9C is a cross-sectional view parallel to an XZ plane, schematically showing Modification 3 of the optical device according to the present embodiment;

FIG. 10A is a cross-sectional view parallel to an XZ plane, schematically showing Modification 4 of the optical device according to the present embodiment;

FIG. 10B is a cross-sectional view parallel to an XZ plane, schematically showing Modification 5 of the optical device according to the present embodiment;

FIG. 11A is a cross-sectional view parallel to an XY plane of a layer including optical waveguides in Modification 6 of the optical device according to the present embodiment;

FIG. 11B is a cross-sectional view parallel to an XY plane of a layer including optical waveguides in Modification 7 of the optical device according to the present embodiment;

FIG. 11C is a cross-sectional view parallel to an XY plane of a layer including optical waveguides in Modification 8 of the optical device according to the present embodiment;

FIG. 11D is a cross-sectional view parallel to an XY plane of a layer including optical waveguides in Modification 9 of the optical device according to the present embodiment;

FIG. 12 shows an example of a structure of an optical scanning device in which an optical divider, a waveguide array, a phase shifter array, and an element, such as a light source, are integrated on a circuit board;

FIG. 13 is a schematic view showing a state in which two-dimensional scanning is performed by applying a light beam, such as a laser light beam, to a distant location from the optical scanning device; and

FIG. 14 is a block diagram showing an example of a structure of a LiDAR system that can produce a ranging image.

### DETAILED DESCRIPTIONS

In the present disclosure, all or a part of a circuit, a unit, a device, a member, or a portion, or all or a part of functional blocks in a block diagram may be implemented by, for example, one electronic circuit or a plurality of electronic circuits including a semiconductor device, a semiconductor integrated circuit (IC), or an LSI (large scale integration). The LSI or IC may be formed by integration on one chip or by combining a plurality of chips. For example, functional blocks other than a storage element may be integrated on one chip. Here, although the circuit is called an LSI or an IC, depending upon the degree of integration, the way the circuit is referred to may change, and the circuit may be referred to as a system LSI, a VLSI (very large scale integration), or a ULSI (ultra large scale integration). A Field Programmable Gate Array (FPGA) that is to be programmed after manufacturing the LSI, or a reconfigurable logic device that can reorganize joining relationships inside the LSI or can set up circuit divisions inside the LSI can be used for the same purpose.

Further, all or a part of functions or operations of a circuit, a unit, a device, a member, or a portion can be executed by software processing. In this case, when the software is recorded on a non-transitory recording medium, such as one or a plurality of ROM, one or a plurality of optical discs, or one or a plurality of hard disk drives, and the software is executed by a processing device (processor), a function that has been specified by the software is executed by the processing device (processor) and a peripheral device. A system or a device may include one or a plurality of non-transitory recording media, where the software is recorded, a processing device (processor), and a required hardware device, such as an interface.

It should be noted that the embodiments that are described below are all comprehensive or specific examples. In the embodiments below, numerical examples, shapes, materials, structural components, arrangement positions and connection modes of the structural components, steps, and the order of steps are examples, and are not intended to limit the technology of the present disclosure. Of the structural components in the embodiments below, the structural components that are not described in an independent claim that indicates the broadest concepts are described as optional structural components. Each figure is a schematic view, and is not necessarily an exact illustration. Further, in each figure, structural components that are essentially the same or that are similar are given the same reference signs. Explanations that overlap may be omitted or simplified. Underlying Knowledge Forming Basis of the Present Disclosure

Before describing the embodiments of the present disclosure below, underlying knowledge forming the basis of the present disclosure is described.

The present inventor has found out that an optical scanning device of the related art has a problem in that it is difficult to scan a space with light without complicating the structure of a device.

For example, in the technology disclosed in International Publication No. 2013/168266, a driving device that rotates a mirror is required. Therefore, there is a problem in that the structure of a device becomes complicated and is not robust with respect to vibration.

In the optical phased array described in Japanese Unexamined Patent Application Publication (Translation of PCT Application) No. 2016-508235, it is necessary to divide light, introduce the divided light into a plurality of column waveguides and a plurality of row waveguides, and guide the light to a plurality of antenna elements that are two-dimensionally arranged. Therefore, wiring of the waveguides for guiding the light becomes very complicated. In addition, a two-dimensional scanning range cannot be made large. Further, in order to two-dimensionally change an amplitude distribution of exist light in a far field of view, it is necessary to connect a phase shifter to each of the plurality of antenna elements that are two-dimensionally arranged and to attach phase control wires to the phase shifters. Therefore, the phases of the light incident upon the plurality of antenna elements that are two-dimensionally arranged are changed by different amounts. Consequently, the structures of the elements become very complicated.

The present inventor focused on the problems above in the related art, and examined structures for solving these problems. The present inventor found out that the problems above can be solved by using a waveguide element including two mirrors that face each other and an optical waveguide layer that is interposed between the mirrors. One of the two mirrors of the waveguide element has a light transmittance that is higher than the light transmittance of the other of the two mirrors, and a part of light that propagates through the optical waveguide layer is caused to exist to the outside. As described below, the direction of the exited light (or the exit angle) can be changed by adjusting the refractive index or the thickness of the optical waveguide layer or the wavelength of light that is input to the optical waveguide layer. More specifically, by changing the refractive index, the thickness, or the wavelength, it is possible to change a component, in a direction along a longitudinal direction of the optical waveguide layer, of a wave vector of the exit light. This causes one-dimensional scanning to be realized.

Further, when an array of a plurality of waveguide elements is used, it is also possible to realize two-dimensional scanning. More specifically, by causing light that is supplied to the plurality of waveguide elements to have a proper phase difference and by adjusting the phase difference, it is possible to change a direction in which beams of the light that exits from the plurality of waveguide elements intensify each other. Changing the phase difference changes a component, in a direction intersecting the direction along the longitudinal direction of each optical waveguide layer, of the wave vector of the exit light. This makes it possible to realize two-dimensional scanning. It should be noted that, even when performing two-dimensional scanning, it is not necessary to change by difference amounts the refractive indices, the thicknesses, or the light wavelengths of the plurality of optical waveguide layers. That is, by causing the light that is supplied to the plurality of optical waveguide layers to have a proper phase difference and by causing at least one of the refractive index, the thickness, and the wavelength of each of the plurality of optical waveguide layers to be changed by the same amount in synchronism with each other, it is possible to perform two-dimensional scanning. In this way, according to the embodiments of the present disclosure, it is possible to realize two-dimensional scanning with light by using a relatively simple structure.

In the present specification, “at least one of the refractive index, the thickness, and the wavelength” means “at least one selected from the group consisting of the refractive index of an optical waveguide layer, the thickness of the optical waveguide layer, and the wavelength of light that is input to the optical waveguide layer”. In order to change a light exit direction, any one of the refractive index, the thickness, and the wavelength may be singly controlled. Alternatively, of the three, any two or all may be controlled to change the light exit direction. In each embodiment below, instead of or in addition to controlling the refractive index or the thickness, the wavelength of light that is input to an optical waveguide layer may be controlled.

The basic principle above can be similarly used not only when causing light to exit but also when receiving a light signal. By changing at least one of the refractive index, the thickness, and the wavelength, it is possible to one-dimensionally change a direction of light that can be received. Further, when the phase difference of light is changed by a plurality of phase shifters that are connected to respective waveguide elements that are arranged in one direction, it is possible to two-dimensionally change the direction of light that can be received.

An optical scanning device and an optical receiving device according to the embodiments of the present disclosure may be used as, for example, antennas in a light detection system, such as a LiDAR (Light Detection and Ranging) system. Since, compared to a radar system using radio waves, such as millimeter waves, the LiDAR system uses electromagnetic waves (visible light, infrared rays, or ultraviolet rays) having short wavelengths, the LiDAR system can detect an object distance distribution with high resolution. Such a LiDAR system may be used as one collision avoidance technology by being installed in, for example, a movable object such as an automobile, a UAV (Unmanned Aerial Vehicle, a so-called drone) or an AGV (Automated Guided Vehicle). In the present specification, the optical scanning device and the optical receiving device may be collectively called “optical device”. In addition, a device that is used in the optical scanning device or the optical receiving device may also be called an “optical device”.

A basic structural example of an optical device and operating principles thereof are described below.

### Basic Structural Example of Optical Scanning Device

As an example, a structure of an optical scanning device that performs two-dimensional scanning is described below. However, detailed descriptions considered as excessive may be omitted. For example, detailed descriptions about matters that are already well known may be omitted. This is to avoid unnecessarily exaggerating the descriptions below to facilitate understanding to those skilled in the art.

In the present disclosure, “light” means not only visible light (wavelengths of approximately 400 nm to approximately 700 nm), but also electromagnetic waves including ultraviolet rays (wavelengths of approximately 10 nm to approximately 400 nm) and infrared rays (wavelengths of approximately 700 nm to approximately 1 mm). In the present specification, ultraviolet rays may be called “ultraviolet light”, and infrared rays may be called “infrared light”.

In the present disclosure, “scanning” with light means changing a light direction. “One-dimensional scanning” means linearly changing a light direction along a direction intersecting the light direction. “Two-dimensional scanning” means two-dimensionally changing a light direction along a plane intersecting the light direction.

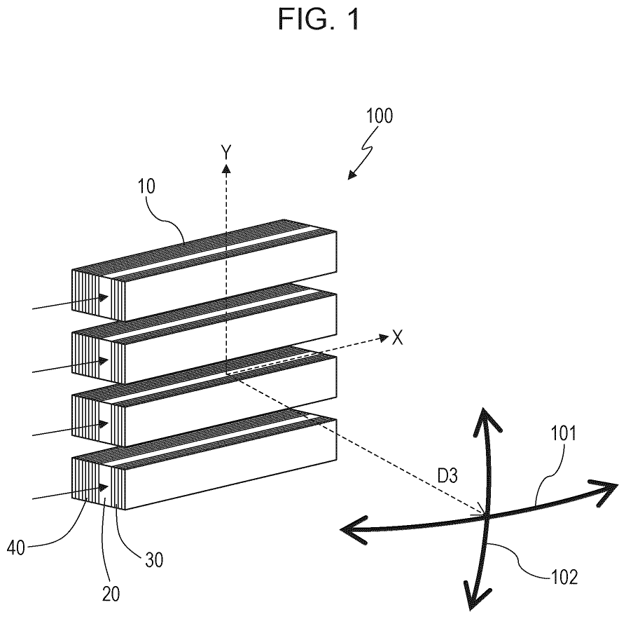

FIG. 1 is a perspective view schematically showing a structure of an optical scanning device 100. The optical scanning device 100 includes a waveguide array including a plurality of waveguide elements 10. Each of the plurality of waveguide elements 10 has a shape extending in a first direction (X direction in FIG. 1). The plurality of waveguide elements 10 are arranged regularly in a second direction (Y direction in FIG. 1) intersecting the first direction. The plurality of waveguide elements 10, while allowing light to propagate in the first direction, allows the light to exit in a third direction D3 intersecting an imaginary plane parallel to the first direction and the second direction. In the present embodiment, although the first direction (the X direction) and the second direction (the Y direction) are orthogonal to each other, they need not be orthogonal to each other. In the present embodiment, although the plurality of waveguide elements 10 are disposed side by side at equal intervals in the Y direction, they need not be necessarily disposed side by side at equal intervals.

It should be noted that orientations of structural objects shown in the drawings of the present disclosure are set in consideration of ease of understanding of description, and that this does not limit in any way the orientations when the present embodiments are actually carried out. The shape and size of the entire or a part of each structural object that is shown in the drawings do not limit the actual shape and size.

Each of the plurality of waveguide elements 10 includes a first mirror 30 and a second mirror 40 that face each other, and an optical waveguide layer 20 that is positioned between the mirror 30 and the mirror 40. Each of the mirrors 30 and 40 has a reflection surface at an interface between it and the optical waveguide layer 20, the reflection surface intersecting the third direction D3. The mirrors 30 and 40 and the optical waveguide layer 20 each have a shape extending in the first direction (the X direction).

It should be noted that, as described below, the plurality of first mirrors 30 of the plurality of waveguide elements 10 may be a plurality of portions of the mirrors that are integrally formed. The plurality of second mirrors 40 of the plurality of waveguide elements 10 may be a plurality of portions of the mirrors that are integrally formed. Further, the plurality of optical waveguide layers 20 of the plurality of waveguide elements 10 may be a plurality of portions of the optical waveguide layers that are integrally formed. It is possible to form a plurality of waveguides depending upon at least (1) whether each first mirror 30 is formed separately from the other first mirrors 30, (2) whether each second mirror 40 is formed separately from the other second mirrors 40, and (3) whether each optical waveguide layer 20 is formed separately from the other optical waveguide layers 20. “Formed separately” means not only “being physically disposed apart from each other with a space therebetween”, but also “being separated with a material having a different refractive index being interposed therebetween”.

The reflection surface of each first mirror 30 and the reflection surface of each second mirror 40 face each other in a substantially parallel manner. Of two mirrors, that is, the mirror 30 and the mirror 40, at least the first mirror 30 has the characteristic of transmitting therethrough a part of light that propagates through the optical waveguide layer 20. In other words, the first mirror 30 has with respect to this light a light transmittance that is higher than the light transmittance of the second mirror 40. Therefore, a part of the light that propagates through the optical waveguide layer 20 exits to the outside from the first mirror 30. Such mirrors 30 and 40 may each be, for example, a multilayer mirror formed from a multilayer film (may be referred to as a “multilayer reflection film”) formed from a dielectric.

It is possible to realize two-dimensional scanning with light by controlling the phase of light that is input to each waveguide element 10 and by changing in synchronism and at the same time the refractive indices or the thicknesses of the optical waveguide layers 20 of the respective waveguide elements 10 or the wavelength of light that is input to each optical waveguide layer 20.

In order to realize such two-dimensional scanning, the present inventor analyzed the operating principles of the waveguide elements 10. On the basis of the results, two-dimensional scanning with light was successfully realized by driving the plurality of waveguide elements 10 in synchronism.

As shown in FIG. 1, when light is input to each waveguide element 10, the light exits from an exit surface of each waveguide element 10. The exit surface is positioned on a side opposite to the reflection surface of its corresponding first mirror 30. The exit light direction D3 depends upon the refractive index, the thickness, and the light wavelength of each optical waveguide layer. In the present embodiment, at least one of the refractive index, the thickness, and the wavelength of each optical waveguide layer is controlled in synchronism such that the light that exits from each waveguide element 10 is in substantially the same direction. Therefore, it is possible to change a component in the X direction of a wave vector of the light that exits from each of the plurality of waveguide elements 10. In other words, it is possible to change the exit light direction D3 along a direction 101 shown in FIG. 1.

Further, since the light that exits from each of the plurality of waveguide elements 10 is oriented in the same direction, beams of the exit light interfere with each other. By controlling the phase of the light that exits from each of the waveguide elements 10, it is possible to change a direction in which the beams of the light intensify each other by the interference. For example, when a plurality of waveguide elements 10 having the same size are disposed side by side at equal intervals in the Y direction, light having a phase differing by a certain increment is input to each of the plurality of waveguide elements 10. By changing a phase difference thereof, it is possible to change a component in the Y direction of a wave vector of the exit light. In other words, by changing the phase difference of the light that is introduced into each of the plurality of waveguide elements 10, it is possible to change along a direction 102 shown in FIG. 1 the direction D3 in which the beams of the exit light intensify each other by the interference. Therefore, it is possible to realize two-dimensional scanning with light.

The operating principles of the optical scanning device 100 are described below.

### Operating Principles of Waveguide Elements

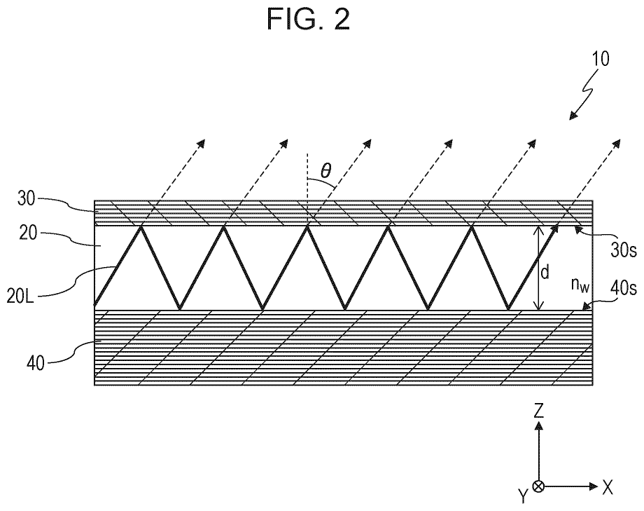

FIG. 2 is a schematic view of an example of a cross-sectional structure of one waveguide element 10 and propagating light. In FIG. 2, a direction perpendicular to the X direction and the Y direction in FIG. 1 is a Z direction, and a cross section parallel to an XZ plane of the waveguide element 10 is schematically shown. In the waveguide element 10, the first mirror 30 and the second mirror 40 are disposed such that the optical waveguide layer 20 is interposed therebetween. The first mirror 30 has a first reflection surface 30s. The second mirror 40 has a second reflection surface 40s facing the first reflection surface 30s. Light 20L introduced from one end of the optical waveguide layer 20 in the X direction propagates inside the optical waveguide layer 20 while repeatedly being reflected by the first reflection surface 30s of the first mirror 30 provided on an upper surface (a surface on an upper side in FIG. 2) of the optical waveguide layer 20 and by the second reflection surface 40s of the second mirror 40 provided on a lower surface (a surface on a lower side in FIG. 2) of the optical waveguide layer 20. The light transmittance of the first mirror 30 is higher than the light transmittance of the second mirror 40. Therefore, it is possible to output primarily a part of the light from the first mirror 30.

In a waveguide such as a general optical fiber, light propagates along the waveguide while being repeatedly totally reflected. In contrast, in the waveguide element 10 of the present embodiment, light propagates while being repeatedly reflected by the mirrors 30 and 40 disposed above and below the optical waveguide layer 20. Therefore, there is no limit to a light propagation angle. Here, “light propagation angle” means an incident angle with respect to an interface between the mirror 30 or the mirror 40 and the optical waveguide layer 20. Light that is incident at an angle closer to a perpendicular angle with respect to the mirror 30 or the mirror 40 can also propagate. That is, light that is incident upon the interface at an angle smaller than a critical angle of total reflection can also propagate. Therefore, a group velocity of light in a light propagation direction is considerably decreased compared to a light velocity in free space. Therefore, the waveguide element 10 has a characteristic of considerably changing light propagation conditions with respect to changes in a light wavelength, the thickness of the optical waveguide layer 20, and the refractive index of the optical waveguide layer 20. Such a waveguide is called a “reflective waveguide” or a slow-light waveguide”.

An exit angle θ of light that exits into air from the waveguide element 10 is expressed by the following Formula (1):

$$sin θ = \sqrt{{n}_{w}^{2} - {( \frac{m λ}{2 d} )}^{2}} \qquad ( 1 )$$

As can be understood from Formula (1), it is possible to change a light exit direction by changing any one of a wavelength λ of light in air, a refractive index n_{w} of the optical waveguide layer 20, and a thickness d of the optical waveguide layer 20.

For example, when n_{w}=2, d=387 nm, λ=1550 nm, and m=1, the exit angle is 0 degrees. From this state, when the refractive index is changed to n_{w}=2.2, the exit angle changes to approximately 66 degrees. On the other hand, when the thickness is changed to d=420 nm without changing the refractive index, the exit angle changes to approximately 51 degrees. When the wavelength is changed to λ=1500 nm without changing the refractive index and the thickness, the exit angle changes to approximately 30 degrees. In this way, it is possible to considerably change the light exit direction by changing any one of the wavelength λ of light, the refractive index n_{w} of the optical waveguide layer 20, and the thickness d of the optical waveguide layer 20.

Accordingly, the optical scanning device 100 controls the light exit direction by controlling at least one of the wavelength λ of light that is input to the optical waveguide layer 20, the refractive index n_{w} of the optical waveguide layer 20, and the thickness d of the optical waveguide layer 20. The wavelength λ of light may be kept at a constant value without being changed during operation. In this case, scanning with light can be realized by using a simpler structure. The wavelength λ is not particularly limited. For example, the wavelength λ may be included in a wavelength range of 400 nm to 1100 nm (that is, from visible light to near infrared light) at which a high detection sensitivity can be obtained by an image sensor or a photodetector that detects light by absorption of light by general silicon (Si). In another example, the wavelength λ may be included in a wavelength range of near infrared light of 1260 nm to 1625 nm at which transmission loss is relatively small in an optical fiber or an Si waveguide. It should be noted that these wavelength ranges are examples. The wavelength range of light that is used is not limited to the wavelength range of visible light or the wavelength range of infrared light, and may be, for example, the wavelength range of ultraviolet light.

In order to change the exit light direction, the optical scanning device 100 may include a first adjustment element that changes at least one of the refractive index, the thickness, and the wavelength of the optical waveguide layer 20 of each waveguide element 10.

As described above, when a waveguide element 10 is used, it is possible to considerably change the light exit direction by changing at least one of the refractive index n_{w}, the thickness d, and the wavelength λ of the optical waveguide layer 20. Therefore, the exit angle of light that exits from the mirror 30 can be changed to a direction along the waveguide element 10. It is possible to realize such one-dimensional scanning by using at least one waveguide element 10.

In order to adjust the refractive index of at least a part of an optical waveguide layer 20, the optical waveguide layer 20 may include a liquid crystal material or an electro-optical material. The optical waveguide layer 20 may be interposed between a pair of electrodes. It is possible to change the refractive index of the optical waveguide layer 20 by applying a voltage to the pair of electrodes.

In order to adjust the thickness of an optical waveguide layer 20, for example, at least one actuator may be connected to at least one of the mirror 30 and the mirror 40. It is possible to change the thickness of the optical waveguide layer 20 by changing the distance between the mirror 30 and the mirror 40 by the at least one actuator. If the optical waveguide layer 20 is formed from a liquid, the thickness of the optical waveguide layer 20 can be easily changed.

### Operating Principles of Two-Dimensional Scanning

In a waveguide array in which a plurality of waveguide elements 10 are arranged in one direction, the light exit direction is changed by interference of light that exits from each waveguide element 10. It is possible to change the light exit direction by adjusting the phase of the light that is supplied to each waveguide element 10. The principles thereof are described below.

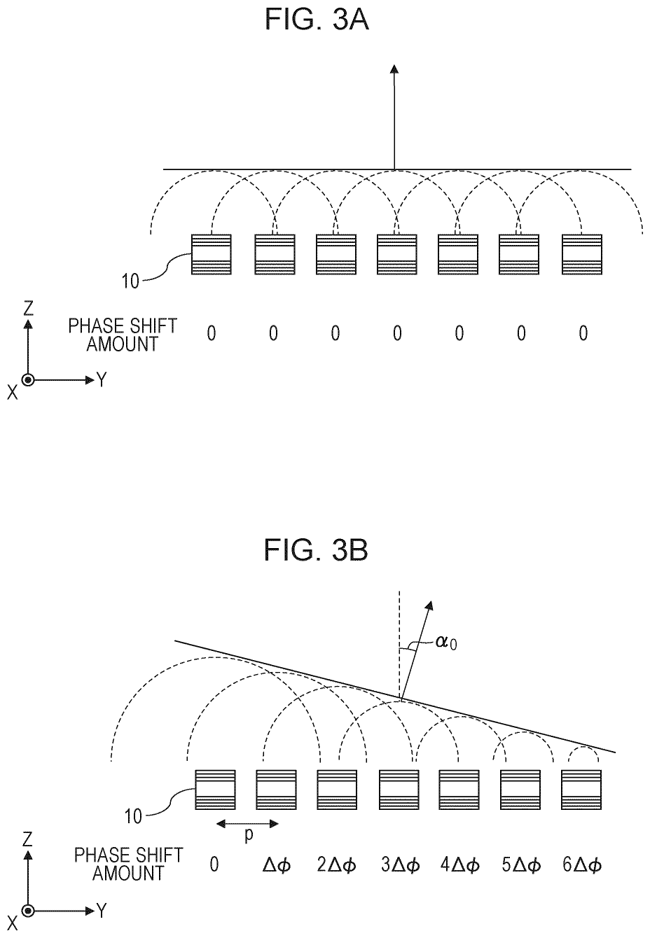

FIG. 3A is a cross-sectional view of a waveguide array from which light exits in a direction perpendicular to a light exit surface of the waveguide array. FIG. 3A also shows a phase shift amount of light that propagates through each waveguide element 10. Here, the phase shift amount is a value with reference to a phase of light that propagates through the waveguide element 10 at a left end. The waveguide array of the present embodiment includes a plurality of the waveguide elements 10 that are arranged at equal intervals. In FIG. 3A, a broken-line arc indicates a wavefront of the light that exits from each waveguide element 10. A straight line indicates a wavefront formed by interference of the light. An arrow indicates the direction of the light that exits from the waveguide array (that is, the direction of a wave vector). In the example of FIG. 3A, the phases of beams of light that propagates through optical waveguide layers 20 of the respective waveguide elements 10 are the same. In this case, the light exits in a direction (the Z direction) perpendicular to both an arrangement direction of the waveguide elements 10 (the Y direction) and the direction of extension of the optical waveguide layers 20 (the X direction).

FIG. 3B is a cross-sectional view of the waveguide array from which light exits in a direction differing from the direction perpendicular to the light exit surface of the waveguide array. In the example shown in FIG. 3B, the phases of beams of light that propagate through the optical waveguide layers 20 of the plurality of waveguide elements 10 differ by an increment of a constant amount (Δφ) in an arrangement direction. In this case, the light exits in a direction differing from the Z direction. It is possible to change a component in the Y direction of a wave vector of the light by changing this Δφ. When a center-to-center distance between two waveguide elements 10 that are adjacent to each other is p, an exit angle do of the light is expressed by the following Formula (2):

$$sin {α}_{0} = \frac{Δϕλ}{2 π p} \qquad ( 2 )$$

In the example shown in FIG. 2, the light exit direction is parallel to the XZ plane. That is, α₀=0 degrees. In the examples shown in FIGS. 3A and 3B, the direction of the light that exits from the optical scanning device 100 is parallel to a YZ plane. That is, θ=0 degrees. However, in general, the direction of the light that exits from the optical scanning device 100 is not parallel to the XZ plane and the YZ plane. That is, θ≠0 degrees and α₀≠0 degrees.

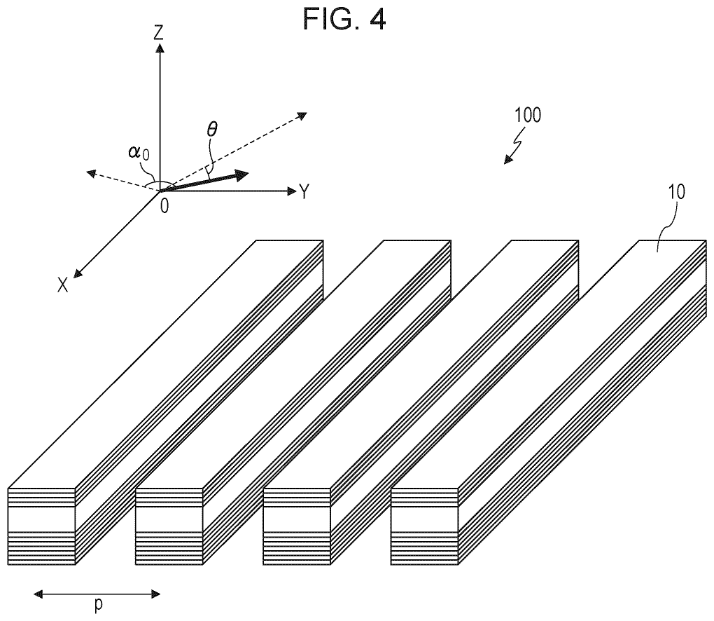

FIG. 4 is a perspective view schematically showing a waveguide array in three-dimensional space. A thick arrow shown in FIG. 4 indicates a direction of light that exits from an optical scanning device 100. θ denotes an angle formed by the light exit direction and a YZ plane. θ satisfies Formula (1). α₀ denotes an angle formed by the light exit direction and an XZ plane. α₀ satisfies Formula (2).

### Phase Control of Light Introduced to Waveguide Array

In order to control the phase of light that exits from each waveguide element 10, for example, a phase shifter for changing the phase of the light may be provided at a stage before introducing the light to each waveguide element 10. The optical scanning device 100 includes a plurality of phase shifters that are connected to the respective waveguide elements 10, and a second adjustment element that adjusts the phase of light that propagates through each phase shifter. Each phase shifter includes a waveguide that is connected directly to an optical waveguide layer 20 of a corresponding one of the plurality of waveguide elements 10 or that is connected thereto through another waveguide. The second adjustment element changes phase differences of beams of light that propagate to the plurality of waveguide elements 10 from the plurality of phase shifters to change the direction of beams of light that exit from the plurality of waveguide elements 10 (that is, the third direction D3). In the description below, similarly to the waveguide array, the plurality of phase shifters that are arranged may also be called a “phase shifter array”.

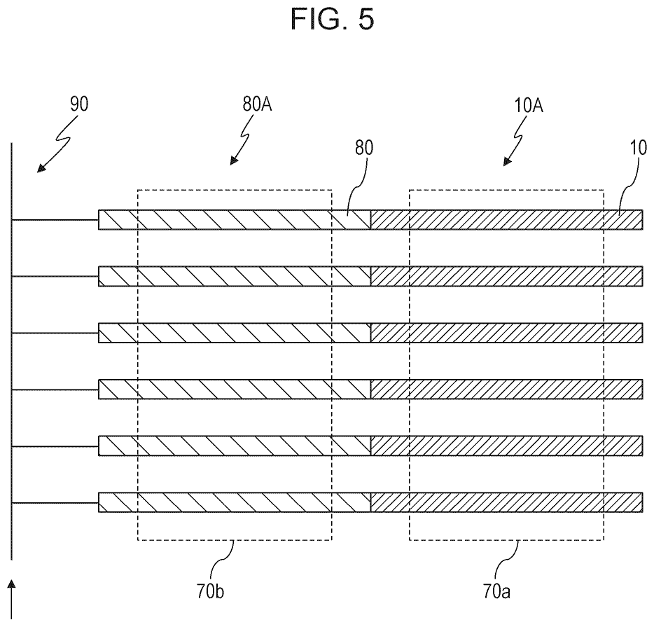

FIG. 5 is a schematic view of a waveguide array 10A and a phase shifter array 80A as seen from a normal direction to a light exit surface (the Z direction). In the example shown in FIG. 5, all phase shifters 80 have the same propagation characteristics, and all waveguide elements 10 have the same propagation characteristics. Each phase shifter 80 and each waveguide element 10 may have the same length, or may have different lengths. When the lengths of the respective phase shifters 80 are equal to each other, for example, it is possible to adjust the phase shift amounts by a driving voltage. By using a structure in which the lengths of the phase shifters 80 are changed by equal steps, phase shifts of equal steps can be provided by the same driving voltage. Further, the optical scanning device 100 includes an optical divider 90 that divides and supplies light to the plurality of phase shifters 80, a first driving circuit 70a that drives each waveguide element 10, and a second driving circuit 70b that drives each phase shifter 80. A straight-line arrow in FIG. 5 indicates input of light. It is possible to realize two-dimensional scanning by independently controlling the first driving circuit 70a and the second driving circuit 70b that are separately provided. In this example, the first driving circuit 70a functions as one component of the first adjustment element, and the second driving circuit 70b functions as one component of the second adjustment element.

The first driving circuit 70a changes the angle of light that exits from each optical waveguide layer 20 by changing at least one of the refractive index and the thickness of the optical waveguide layer 20 of each waveguide element 10. The second driving circuit 70b changes the phase of light that propagates inside each optical waveguide layer 20 by changing the refractive index of the optical waveguide layer 20 at each phase shifter 80. The optical divider 90 may be formed from a waveguide through which light propagates by total reflection, or from a reflective waveguide similar to that of each waveguide element 10.

It should be noted that, after controlling the phases of beams of the light divided by the optical divider 90, the beams of the light may be introduced to the phase shifters 80. For the phase control, for example, a passive phase control structure in which the length of the waveguide up to its corresponding phase shifter 80 is adjusted can be used. Alternatively, a phase shifter that can be controlled by an electrical signal having the same function as the phase shifters 80 may be used. By such a method, the phases may be adjusted before the beams of the light are introduced to the respective phase shifters 80 such that the beams of the light of equal phases are supplied to all of the phase shifters 80. By such an adjustment, it is possible to simplify the control of each phase shifter 80 by the second driving circuit 70b.

An optical device having a structure similar to the structure of the optical scanning device 100 above can also be used as an optical receiving device. The details of, for example, the operating principles and the operating method of the optical device are disclosed in U.S. Patent application Publication No. 2018/0224709. The disclosed content of this document is incorporated herein in its entirety by reference.

Problems Occurring in Optical Device in which Light is Input to Slow-Light Waveguide from Total Reflection Waveguide

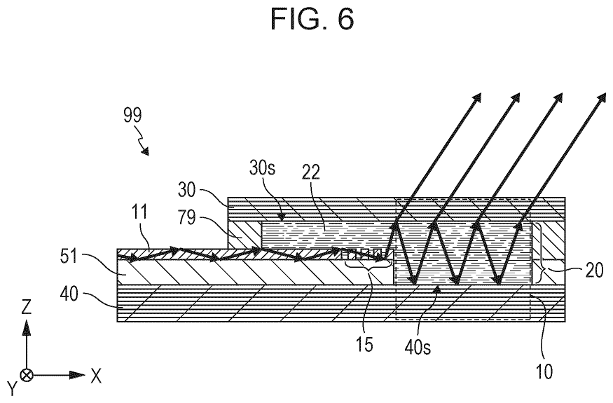

With reference to FIG. 6, problems occurring in an optical device in which light is input to a slow-light waveguide from a total reflection waveguide are described below. The total reflection waveguide is a waveguide in which light propagates by total reflection. Here, “total reflection” means a phenomenon in which, when light is incident upon a low refractive index medium from a high refractive index medium at an angle greater than or equal to a critical angle, all the light is reflected.

FIG. 6 is a cross-sectional view parallel to an XZ plane, schematically showing a structure of an optical device according to a comparative example. A thick arrow shown in FIG. 6 indicates the flow of light. In an optical device 99 shown in FIG. 6, a total reflection waveguide is connected to a slow-light waveguide.

As shown in FIG. 6, the optical device 99 includes a mirror 30, a mirror 40, a liquid crystal layer 22 that is positioned between the mirrors 30 and 40 and that includes a liquid crystal material, and a seal member 79 that seals the liquid crystal layer 22. The optical device 99 further includes an optical waveguide 11, a part of which is positioned in the liquid crystal layer 22, and a dielectric layer 51 that is provided on the mirror 40 and that supports the optical waveguide 11. The optical waveguide 11 is a total reflection waveguide in which light propagates in the X direction by total reflection.

In the present specification, the X direction that is a direction in which light propagates through the optical waveguide 11 is a “forward direction”, a direction opposite thereto is a “rearward direction”, a side where the mirror 30 is positioned is an “upward direction”, and a side where the mirror 40 is positioned is a “downward direction”.

In the optical device 99, a portion that is positioned forward of the optical waveguide 11 and that includes the mirror 30, the mirror 40, and the liquid crystal layer 22 that is interposed between the mirrors 30 and 40 corresponds to a waveguide element 10 above. The waveguide element 10 functions as a slow-light waveguide. Of the liquid crystal layer 22, a portion that is positioned inside the waveguide element 10 corresponds to an optical waveguide layer 20. “Top view” means viewing from a normal direction to a reflection surface 40s of the mirror 40. A normal direction to a surface of an object is perpendicular to this surface and is a direction away from the object.

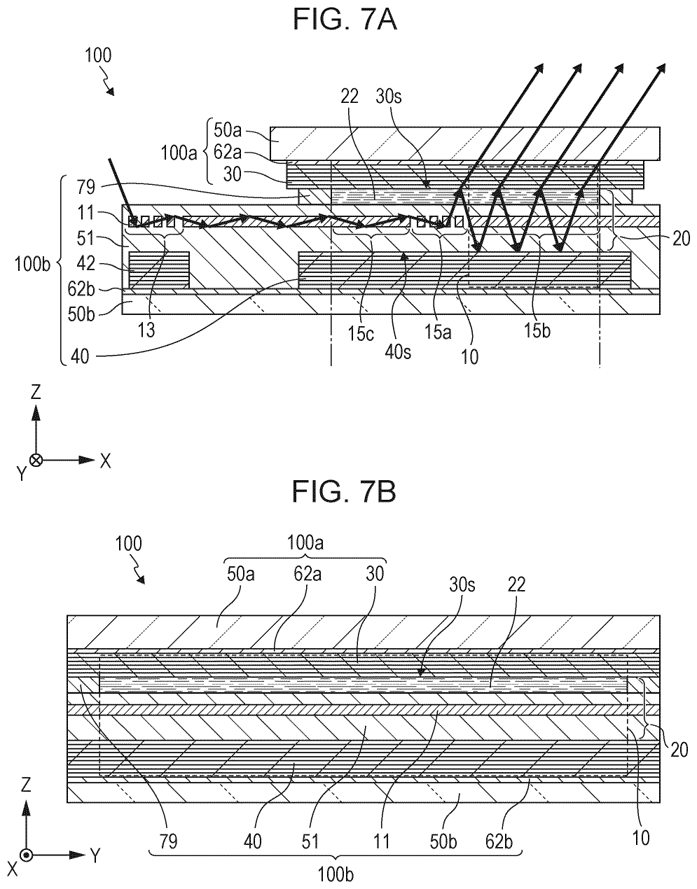

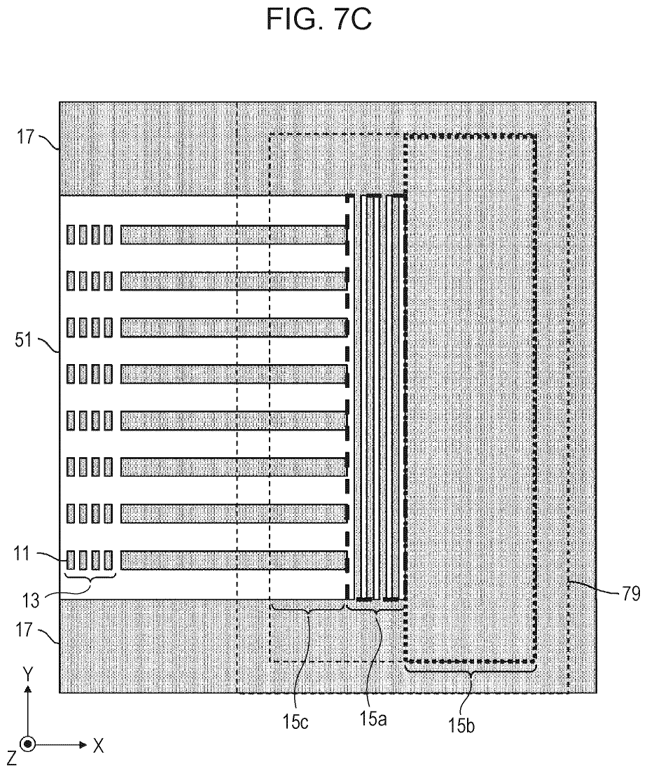

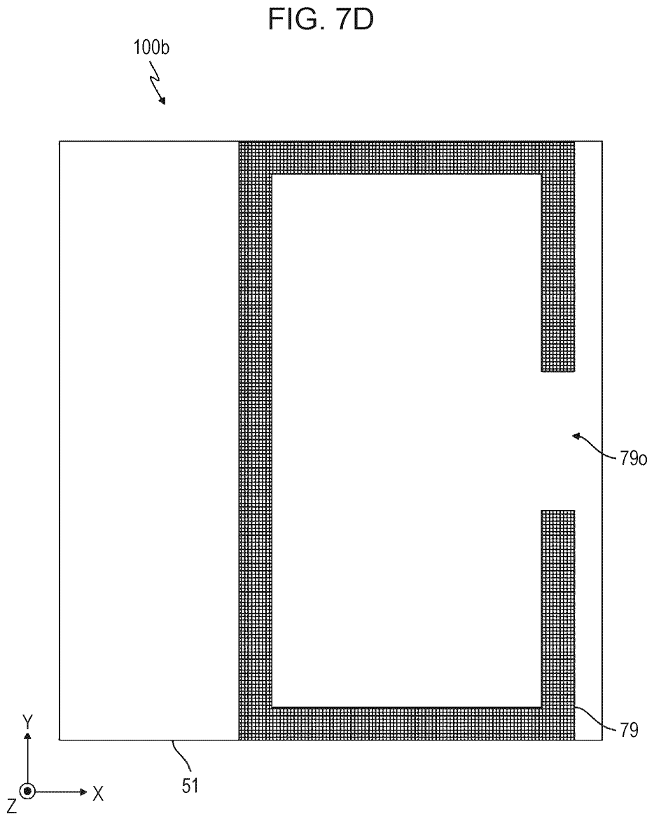

The optical waveguide 11 includes, at a portion thereof that is positioned inside the optical waveguide layer 20, a light extraction region 15 where one or more gratings are provided. The light extraction region 15 increases a coupling efficiency of light from the optical waveguide 11 to the waveguide element 10. It should be noted that the light extraction region 15 is different from a region (e.g., the upper-portion structural body 100a shown in FIG. 7A) that extracts light to the outside of the optical device 100.

A propagation constant of a waveguide mode in the optical waveguide 11 is β₁=2πnₑ₁/λ, and a propagation constant of a waveguide mode in the waveguide element 10 is β₂=2πnₑ₂/λ. λ is the wavelength of light in air. nₑ₁ and nₑ₂ are respectively an effective refractive index (also called an equivalent refractive index) of the optical waveguide 11 and an effective refractive index of the waveguide element 10. Light that propagates inside the optical waveguide 11 does not couple to outside air. An effective refractive index of such a waveguide mode is nₑ₁>1. On the other hand, a part of light that propagates through the optical waveguide layer 20 in the waveguide element 10 exits to the outside air. An effective refractive index of such a waveguide mode is 0<nₑ₂<1. Therefore, β₁ and β₂ considerably differ, as a result of which the coupling efficiency of the light from the optical waveguide 11 to the waveguide element 10 is generally low.

When the optical waveguide 11 includes the light extraction region 15, diffraction occurs due to the one or more gratings included in the light extraction region 15. As a result, the propagation constant β1 shifts by an integral multiple of a reciprocal lattice 2πp with a grating period being p. For example, when due to −1 order diffraction, β₁ shifts to β₁−(2πp), and p is properly set, β₁−(2πp)=β₂ is established. In the light extraction region 15, since the two propagation constants are the same, the light couples with high efficiency to the waveguide element 10 from the optical waveguide 11. From β₁−(2π/p)=β₂, the period p becomes λ/(nₑ₁−nₑ₂).

In the optical device 99 according to the comparative example, the light that propagates through the optical waveguide 11 is extracted from the light extraction region 15 and couples to the optical waveguide layer 20. The light that propagates through the optical waveguide layer 20 exits to the outside through the mirror 30. By applying a voltage to the optical waveguide layer 20 including the liquid crystal material, the refractive index of the liquid crystal layer 22 changes, as a result of which it is possible to change the exit direction of the light that exits through the mirror 30. As a result, it is possible to perform scanning with light.

In the optical device 99, it is possible to say that if the refractive index of the entire optical waveguide layer 20 is changed, a scanning range can be widened. Therefore, in order to provide the entire optical waveguide layer 20 with the liquid crystal material, in the optical device 99, processing is performed such that the optical waveguide 11 and the dielectric layer 51 become terminal ends. In such a structure, the following problems occur.

Light that was not extracted from the light extraction region 15 may exit to the outside as scattered light from a terminal end portion of the optical waveguide 11 through the mirror 30. This light is caused to be incident again upon the light extraction region 15 by reflection at the terminal end portion. The former exit light becomes noise light that is not easily spatially separated from light used in scanning in optical scanning. The latter reflected light becomes returning light, and may cause light loss when extracting the light that propagates through the optical waveguide 11 from the light extraction region 15.

In order to suppress the noise light and the light loss, in the optical device 99, the terminal end portion of the optical waveguide 11 and a terminal end portion of the dielectric layer 51 are strictly designed to units of ten and several nm. When the terminal end portions are processed by using a semiconductor process, on the basis of a strict design, the optical waveguide 11 and the dielectric layer 51 that are made of different types of materials are etched with high precision. Specifically, after etching the optical waveguide 11, requirements are changed to etch the dielectric layer 51. In this way, in manufacturing the optical device 99, high processing precision is required and the number of processes is increased.

The inventors examined the problems above occurring in the optical device 99 according to the comparative example, and arrived at the idea of providing an optical device according to an embodiment of the present disclosure that can solve the problems above. The optical device according to the present embodiment is described below.

### Embodiments

An optical device according to an embodiment of the present disclosure is described below with reference to FIGS. 7A to 7C. Although, in the description below, the optical device is described as an optical scanning device, the optical device can also be used as a light detection device.

### Structure of Optical Device

FIGS. 7A and 7B are respectively a cross-sectional view parallel to an XZ plane and a cross-sectional view parallel to a YZ plane, each schematically showing a structure of an optical device 100 according to an exemplary embodiment of the present disclosure. A thick arrow shown in FIG. 7A indicates the flow of light. The optical device 100 shown in FIGS. 7A and 7B includes an upper-portion structural body 100a, a lower-portion structural body 100b, and a liquid crystal layer 22 that is positioned therebetween. The liquid crystal layer 22 is filled with a liquid crystal material. The optical device 100 is manufactured by affixing the upper-portion structural body 100a and the lower-portion structural body 100b to each other and injecting a liquid crystal material into a space provided therebetween.

The upper-portion structural body 100a includes a substrate 50a, an electrode 62a, and a mirror 30 in this order. The lower-portion structural body 100b includes a substrate 50b and an electrode 62b in this order. The lower-portion structural body 100b further includes a mirror 40 and a sub-mirror 42 that are provided on the electrode 62b. The lower-portion structural body 100b further includes an optical waveguide 11 that is positioned above the mirror 40 and the sub-mirror 42, and a dielectric layer 51 that fills a gap between the mirror 40, the sub-mirror 42, and the optical waveguide 11 and that covers the optical waveguide 11. The lower-portion structural body 100b further includes a seal member 79 that is provided on the dielectric layer 51 and that seals the liquid crystal layer 22.

FIG. 7C is a cross-sectional view parallel to an XY plane of a layer including optical waveguides 11 in the optical device 100 shown in FIGS. 7A and 7B. For reference, in FIG. 7C, the seal member 79 having a rectangular ring shape is denoted by a broken line. FIG. 7D is a top view schematically showing the lower-portion structural body 100b before affixing thereto the upper-portion structural body 100a in the optical device 100 shown in FIGS. 7A and 7B.

Although described in detail later, in the optical device 100 according to the present embodiment, as shown in FIG. 7A, the optical waveguide 11 includes a first region 15a where light is extracted, and a second region 15b through which light that could not be extracted propagates. In top view, the first region 15a and the second region 15b overlap all of the mirror 30, the mirror 40, and the liquid crystal layer 22.

Therefore, in the optical device 100 according to the present embodiment, unlike the optical device 99 according to the comparative example, as shown in FIG. 7A, the optical waveguide 11 and the dielectric layer 51 made of different types of materials do not need to become terminal ends. As a result, manufacturing is facilitated and the optical device 100 that can perform scanning with light can be realized.

Each structural component of the optical device 100 according to the present embodiment is described below.

### Substrates 50a and 50b

The substrates 50a and 50b each have a shape extending along the XY plane. Of the substrates 50a and 50b, the substrate on a side from which light exits is light transmissive. Both of the substrates 50a and 50b may be light-transmissive. Although, in the example shown in FIG. 7A, light exits from the upper-portion structural body 100a, it is not limited thereto. Light may exit from the lower-portion structural body 100b, or light may exit from the upper-portion structural body 100a and the lower-portion structural body 100b.

### Electrodes 62a and 62b

The electrodes 62a and 62b each have a shape extending along the XY plane. Of the electrodes 62a and 62b, the electrode on a side from which light exits is light transmissive. Both of the electrodes 62a and 62b may be light transmissive. At least one of the electrodes 62a and 62b may be formed from, for example, a transparent electrode.

The electrodes 62a and 62b face each other such that the liquid crystal layer 22 is indirectly interposed therebetween. “Indirectly interposed” means interposed with another member being disposed therebetween. The positional relationship between the electrode 62a and the mirror 30 may be reversed. Similarly, the positional relationship between the electrode 62b and the mirror 40 may be reversed. By adjusting a voltage that is applied between the electrodes 62a and 62b, it is possible to adjust the refractive index of a liquid crystal material that is included in the liquid crystal layer 22.

### Mirrors 30 and 40

The mirrors 30 and 40 each have a shape extending along the XY plane. A reflection surface 30s of the mirror 30 and a reflection surface 40s of the mirror 40 are parallel to each other along the XY plane. The mirror 40 is disposed to face the mirror 30. The reflection surface 40s of the mirror 40 faces the reflection surface 30s of the mirror 30. When light exits from the upper-portion structural body 100a, the light transmittance of the mirror 30 is higher than the light transmittance of the mirror 40. When light exits from the lower-portion structural body 100b, the light transmittance of the mirror 40 is higher than the light transmittance of the mirror 30. When light exits from the upper-portion structural body 100a and the lower-portion structural body 100b, the light transmittances of the mirrors 30 and 40 are about the same, and their difference may be, for example, less than or equal to 0.01%.

### Optical Waveguide 11 and Dielectric Layer 51

As shown in FIG. 7A, the optical waveguide 11 is a total reflection waveguide in which light propagates in the X direction by total reflection. The dielectric layer 51 functions as a cladding layer. The refractive index of the optical waveguide 11 is higher than the refractive index of the dielectric layer 51. It should be noted that, as the optical waveguide 11, a slow-light waveguide may be used.

In the present specification, the direction of propagation of light in the optical waveguide 11 is referred to as a “predetermined direction”. It can be said that the XY plane is a plane parallel to the predetermined direction and a direction intersecting the predetermined direction. The predetermined direction is also referred to as a “first direction”, and the direction intersecting the predetermined direction is also referred to as a “second direction”. As the first direction and the second direction, the X direction and the Y direction may be selected. However, the second direction need not be necessarily orthogonal to the first direction.

The optical waveguide 11 has a portion that is positioned between the mirror 30 and the mirror 40. The optical waveguide 11, at this portion, includes the first region 15a where light is extracted and the second region 15b where light that could not be extracted propagates. The second region 15b is provided on a side opposite to a light input side of the first region 15a. A start end of the second region 15b coincides with an end portion on the side opposite to the light input side of the first region 15a.

The first region 15a includes one or more gratings whose refractive index periodically changes along the X direction. The principles of extracting light by the one or more gratings are as described above. The second region 15b does not include such a grating. In top view, the first region 15a and the second region 15b overlap all of the mirror 30, the mirror 40, and the liquid crystal layer 22.

Therefore, the optical waveguide 11 and the dielectric layer 51 that are made of different types of materials do not need to be terminal ends. Since a process itself of forming a terminal end surface of the optical waveguide 11 and a terminal end surface of the dielectric layer 51 does not exist, in manufacturing the optical device 100, the number of processes can be decreased and a high processing precision is not required. As a result, the manufacturing is facilitated and the optical device 100 that can perform scanning with light can be realized.

In the optical device 100, a portion that extends to the mirror 40 from the mirror 30 and that is positioned forward of the first region 15a and where, in top view, the liquid crystal layer 22, the mirror 30, and the mirror 40 all overlap each other corresponds to the waveguide element 10 above. The waveguide element 10 functions as a slow-light waveguide. Of the waveguide element 10, a region corresponding to the optical waveguide layer 20 above is formed between the reflection surface 30s of the mirror 30 and the reflection surface 40s of the mirror 40. This region is referred to as an “optical waveguide region 20”. As shown in FIGS. 7A and 7B, the optical waveguide region 20 functions as a planar optical waveguide having a shape extending along the XY plane.

As shown in FIG. 7A, in top view, the optical waveguide 11 has a portion that overlaps the substrate 50b but that does not overlap the substrate 50a. The optical waveguide 11, at this portion, may further include a light input region 13 for inputting light from the outside. The light input region 13 includes one or more gratings whose refractive index periodically changes along the X direction. Due to the light input region 13, it is possible to effectively couple the input light to the optical waveguide 11.

The number of optical waveguides 11 is at least one. In one-dimensional scanning, the number of optical waveguides 11 may be one or more than one. In two-dimensional scanning, the number of optical waveguides 11 is more than one.

When the number of optical waveguides 11 is more than one, for example, as shown in FIG. 7C, a plurality of optical waveguides 11 may be disposed along the Y direction. The plurality of optical waveguides 11 each have, for example, the same structure. Each optical waveguide 11 has a portion extending along the X direction at a location rearward of the first region 15a. A dimension in the Y direction, that is, the width of this portion may be set such that, for example, a waveguide mode with respect to the wavelength of input light becomes a single mode. Therefore, it is possible to suppress interference of a multimode. However, if interference of a multimode is allowed, the width of each optical waveguide 11 may be set such that a waveguide mode with respect to the wavelength of input light becomes a multimode.

As shown in FIG. 7C, the first region 15a is a single region that is shared by the plurality of optical waveguides 11. A region that is surrounded by a thick broken line shown in FIG. 7C represents the first region 15a. Grooves of the one or more gratings that are provided in the first region 15a extend along the Y direction. The width of the first region 15a is defined by the dimension in the Y direction of the grooves of the one or more gratings.

Similarly, the second region 15b is a single region that is shared by the plurality of optical waveguides 11. A region surrounded by a thick dotted line shown in FIG. 7C represents the second region 15b. The second region 15b is positioned forward of the first region 15a. The width of the second region 15b is defined by the dimension in the Y direction of a region where all of the mirror 30, the mirror 40, and the liquid crystal layer 22 overlap each other.

The relationship between the dimensions in the X direction, that is, the lengths of the first region 15a and the second region 15b is described below. The relationship between the widths of the first region 15a and the second region 15b is also similarly described below.

As shown in FIG. 7C, the lower-portion structural body 100b may include two non-waveguide regions 17 that do not contribute to light propagation, one on each side of a region where the plurality of optical waveguides 11 are provided. The plurality of optical waveguides 11 and the non-waveguide regions 17 are formed as follows. On a flat upper surface of a lower layer corresponding to a part of the dielectric layer 51, another dielectric layer having a shape extending along the XY plane is formed, and, of the other dielectric layer, an unnecessary portion is removed. Although the non-waveguide regions 17 may be removed, since the number of portions to be removed is decreased when the non-waveguide regions 17 are left, manufacturing is facilitated. The removed portion is embedded in an intermediate layer corresponding to another part of the dielectric layer 51. An upper layer corresponding to a remaining portion of the dielectric layer 51 is formed on the plurality of optical waveguides 11, the non-waveguide regions 17, and the intermediate layer. The upper layer has a shape extending along the XY plane.

It should be noted that the upper layer need not be provided. That is, the liquid crystal layer 22 shown in FIGS. 7A and 7B may be positioned on the plurality of optical waveguides 11 without the upper layer being interposed therebetween. Alternatively, not only the upper layer but also the intermediate layer need not be provided. In this case, the seal member 79 may be provided to be embedded in a gap between two optical waveguides 11 that are adjacent to each other such that the liquid crystal material does not leak from this gap.

### Submirror 42

As shown in FIG. 7A, the submirror 42 is provided apart from the mirror 40. The submirror 42 has a structure extending along the Y direction. The submirror 42 reflects light that has been input from the outside and that has been transmitted through the light input region 13, and returns this light to the light input region 13.

A space between the submirror 42 and the mirror 40 is useful when forming a through hole extending from an upper surface of the dielectric layer 51 to the electrode 62b and providing a wire. This wire is provided at a position where the wire does not contact the optical waveguide 11. If such a wire need not be provided, the submirror 42 and the mirror 40 may be integrated with each other.

### Liquid Crystal Layer 22

As shown in FIGS. 7A and 7B, the liquid crystal layer 22 has a shape extending along the XY plane. In such a structure, it becomes possible to easily provide an alignment film at the upper surface of the dielectric layer 51 and at the reflection surface 30s of the mirror 30, and to easily orient the liquid crystal material that is included in the liquid crystal layer 22 to a desired direction. When the positional relationship between the mirror 30 and the electrode 62a is reversed, an orientation film may be provided at a surface of the electrode 62a.

### Seal Member 79

As shown in FIGS. 7A and 7B, the seal member 79 surrounds and seals the liquid crystal layer 22. Before affixing the upper-portion structural body 100a and the lower-portion structural body 100b to each other, as shown in FIG. 7D, the seal member 79 is provided on the dielectric layer 51 such that a part having a rectangular ring shape has an open form. The seal member 79 has an opening 790.

After affixing the upper-portion structural body 100a and the lower-portion structural body 100b to each other and injecting the liquid crystal material from the opening 790, the opening 790 of the seal member 79 is closed. A member that closes the opening 790 may be made of, for example, a material that is the same as the material of the seal member 79. After the opening 790 is closed, the seal member 79 has a rectangular ring shape. It should be noted that the seal member 79 need not necessarily have a rectangular ring shape. If the seal member 79 can surround and seal the liquid crystal layer 22, the shape of the seal member 79 is any shape. The seal member 79 may have, for example, a circular ring shape or an elliptical ring shape.

### Operating Principles of Optical Device 100

Light that has been extracted from the first region 15a at the plurality of optical waveguides 11 shown in FIG. 7C couples to the optical waveguide region 20 shown in FIGS. 7A and 7B. The coupled light interferes in the optical wave region 20 that functions as a planar optical waveguide, and radially spreading light beams are formed. As shown in FIG. 7A, the light beams that have been formed in the optical waveguide region 20 exit to the outside through the upper-portion structural body 100a.

In the present specification, “light exists through the upper-portion structural body 100a” may be rephrased as “light exits through the mirror 30” or “light exits through the mirror 30 and the electrode 62a”. Similarly, “light exits from the lower-portion structural body 100b” may be rephrased as “light exits from the mirror 40” or “light exits from the mirror 40 and the electrode 62b”.

Of the wave vector of the light that exits through the upper-portion structural body 100a, a component in the X direction and a component in the Y direction can be changed as follows.

### Change in Component in X Direction

By applying a voltage between the electrodes 62a and 62b, the refractive index of the liquid crystal layer 22 changes. As a result, of the wave vector of the light that exits through the upper-portion structural body 100a, it is possible to change a component in the X direction.

It should be noted that the liquid crystal layer 22 is an exemplification of an adjustment layer whose refractive index can be adjusted. As the adjustment layer, instead of the liquid crystal layer 22, a layer including an electro-optical material other than liquid crystals may be used. Alternatively, as the adjustment layer, a layer whose dimension in the Z direction, that is, whose thickness can be adjusted instead of the refractive index may be used. This layer may include, for example, an air-like gas. In this case, it is possible to change the thickness of the optical waveguide region 20 by changing the position of the upper-portion structural body 100a in the Z direction by using an actuator. When this layer is an air layer, the layer need not be sealed by the seal member 79.

The adjustment layer whose refractive index or thickness can be adjusted can change the refractive index of at least a part of the optical waveguide region 20 and/or the thickness of the optical waveguide region 20. As a result, of an exit direction of light that exits through the upper-portion structural body 100a, it becomes possible to change a component that is parallel to the X direction.

### Change in Component in Y Direction

By inputting light whose phase is shifted by an increment of a constant amount along the Y direction to each of the plurality of optical waveguides 11, of the wave vector of light that exits through the upper-portion structural body 100a, it is possible to change a component parallel to the Y direction. The light whose phase is shifted by an increment of a constant amount along the Y direction may be, for example, light that has propagated through each of the plurality of phase shifters 80 shown in FIG. 5. Alternatively, in order to obtain the light whose phase is shifted by an increment of a constant amount along the Y direction, of each of the optical waveguides 11 shown in FIG. 7C, a portion thereof that is positioned rearward of the first region 15a and that extends along the X direction may function as the phase shifter.

The operating principles of the optical device 100 shown in FIG. 7A differ from the operating principles of the optical device shown in FIGS. 3A and 3B. In the optical device shown in FIGS. 3A and 3B, light that has exited from the plurality of waveguide elements 10 interferes at an upper location therefrom and light beams are formed. In contrast, in the optical device 100 shown in FIG. 7A, the light beams that are formed in the optical waveguide region 20 functioning as a flat-plate optical waveguide exit to the outside through the upper-portion structural body 100a.

The details of, for example, the operating principles and the operating method of an optical device including a planar optical waveguide are disclosed in U.S. Patent application Publication No. 2022/0317481. The disclosed content of this document is incorporated herein in its entirety by reference.

It should be noted that although, in the example shown in FIG. 7A, light is input to the single waveguide element 10 from the plurality of optical waveguides 11, it is not limited to this example. Light may be input to a plurality of waveguide elements 10 from the plurality of optical waveguides 11. In this case, of the plurality of waveguide elements 10, a space between two waveguide elements 10 that are adjacent to each other may be provided with a partition wall that suppresses leakage of light from one of the waveguide elements 10 to the other waveguide element 10. The refractive index of this partition wall is lower than the average refractive index of an optical waveguide region 20 that is included in each waveguide element 10.

### Scanning Range of Exit Light

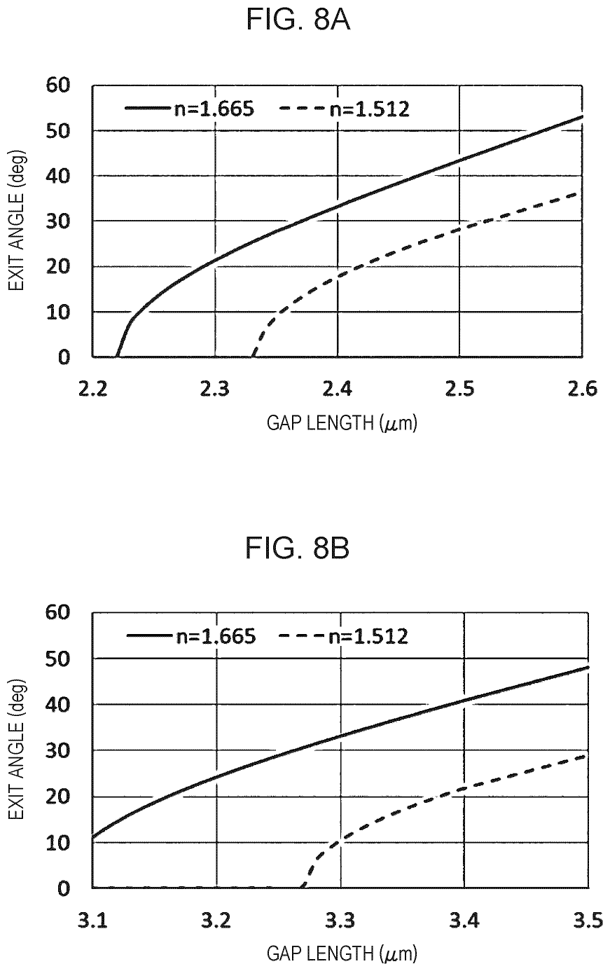

Next, with reference to FIGS. 8A and 8B, the degree of change of the exit angle of light that exits from the mirror 30 due to the liquid crystal material is described. FIGS. 8A and 8B are each a graph showing the relationship between a gap length between the mirror 30 and the mirror 40 and the exist angle of light that exits from the mirror 30. The graph shows the results of calculation by using FemSIM manufactured by Synopsys, Inc. In the calculation, for simplification, in the example shown in FIG. 7A, of the dielectric layer 51, the upper layer above provided on the optical waveguides 11 is assumed as not existing. That is, the liquid crystal layer 22 is positioned in contact with the optical waveguides 11.

In the example shown in FIG. 8A, each optical waveguide 11 has a refractive index of 2.1 and a thickness of 200 nm, and the dielectric layer 51 has a refractive index of 1.46 and a thickness of 900 nm. In the example shown in FIG. 8B, each optical waveguide 11 has a refractive index of 2.1 and a thickness of 200 nm, and the dielectric layer 51 has a refractive index of 1.46 and a thickness of 900 nm. Solid lines shown in FIGS. 8A and 8B indicate a case in which the refractive index of the liquid crystal layer 22 is 1.665, and broken lines shown in FIGS. 8A and 8B indicate a case in which the refractive index of the liquid crystal layer 22 is 1.512.

In each of the calculation examples above, a difference between the solid line and the broken line for a particular gap length corresponds to a scanning range of exit light. In the example shown in FIG. 8A, when the gap length between the mirrors 30 and 40 is 2.4 μm, the scanning range of exit light is approximately 15 degrees. In the example shown in FIG. 8B, when the gap length between the mirrors 30 and 40 is 3.3 μm, the scanning range of exit light is approximately 23 degrees. In the example shown in FIG. 8B, compared to the example shown in FIG. 8A, a ratio of the thickness of the liquid crystal layer 22 to the gap length between the mirrors 30 and 40 is larger. Therefore, in the example shown in FIG. 8B, compared to the example shown in FIG. 8A, the scanning range of exit light becomes wider.

As shown in FIGS. 8A and 8B, it is possible to effectively change the exit light within a wide scanning range even by only changing the refractive index of the liquid crystal layer 22 that is a part of the optical waveguide region 20. Therefore, in order to obtain a wide scanning range, the refractive index of the entire optical waveguide region 20 need not be changed.

### Relationship Between Length of First Region 15a and Length of Second Region 15b

Next, the relationship between the length of the first region 15a and the length of the second region 15b is described. In the optical device 100 shown in FIG. 7A, light that is extracted from the first region 15a includes first light and second light below. The first light exits to the outside from, of the upper-portion structural body 100a, a portion that overlaps the first region 15a in top view. The second light, while propagating through the optical waveguide region 20 included in the waveguide element 10, exits to the outside from, of the upper-portion structural body 100a, a portion that overlaps the second region 15b in top view. Whereas the second light is used in optical scanning, the first light may become noise light in the optical scanning. When the length of the second region 15b is larger than the length of the first region 15a, it is possible to make the amount of second light larger than the amount of first light. Therefore, it is possible to increase the precision of the optical scanning.

Of the upper-portion structural body 100a, the portion that overlaps the second region 15b in the top view corresponds to an opening for exit light. That is, the length of the second region 15b is equal to the length of the opening for exit light. When the wavelength of the exit light is 940 nm, if the length of the second region 15b, that is, the length of the opening for exit light is greater than or equal to 150 μm, a spot diameter of the exit light can be approximately 30 cm at a distance 100 m away. Therefore, a spatial resolution that does not to allow failure of recognition of human beings is possible. Relationship Between Width of First Region 15a and Width of Second Region 15b

Next, the relationship between the width of the first region 15a and the width of the second region 15b is described. By inputting light to each of the plurality of optical waveguides 11 shown in FIG. 7C, radially spreading light beams are formed in the optical waveguide region 20 shown in FIGS. 7A and 7B from the center of the first region 15a in the Y direction. When the width of the second region 15b is larger than the width of the first region 15a, the radially spreading light beams easily propagate in the optical waveguide region 20 that functions as a planar optical waveguide.

### Reduction of Noise Light Due to Second Region 15b

In the optical device 100 shown in FIG. 7A, in top view, of the region where all of the mirror 30, the mirror 40, and the liquid crystal layer 22 overlap each other, in the X direction, an end closer to the first region 15a is a first end, and an end closer to the second region 15b is a second end. An alternate long and short dash line shown in FIG. 7A indicates the first end, and an alternate long and two short dash line shown in FIG. 7A indicates the second end. Of each optical waveguide 11, a portion between the mirrors 30 and 40 reaches the second end from the first end. That is, a terminal end of the second region 15b coincides with the second end.

Due to such a structure, light that could not be extracted from the first region 15a can be moved away from the first region 15a by the second region 15b and can exit to an outer side of the optical waveguide region 20 through the second region 15b. Therefore, in the optical device 100 according to the present embodiment, compared to the optical device 99 according to the comparative example, this light is prevented from exiting as scattered light through the upper-portion structural body 100a. As a result, it is possible to reduce noise light.

When, of each optical waveguide 11, the portion between the mirrors 30 and 40 does not reach the second end from the first end, the terminal end of the second region 15b is positioned rearward of the second end. Even in this case, if the terminal end of the second region 15b is positioned close to the second end, it is possible to reduce the possibility of allowing light that could not be extracted from the first region 15a to exit to the outside as scattered light through the upper-portion structural body 100a. If the distance between the terminal end of the second region 15b and the second end is, for example, less than or equal to 0.1 mm, it can be said that the terminal end of the second region 15b is positioned close to the second end.

As described above, in the optical device 100 according to the present embodiment, as shown in FIG. 7A, in top view, the first region 15a and the second region 15b overlap all of the mirror 30, the mirror 40, and the liquid crystal layer 22. Due to such a structure, since each optical waveguide 11 and the dielectric layer 51 that are made of different types of materials do not need to become terminal ends, it is possible to decrease the number of processes, and high processing precision is not required. Therefore, manufacturing is facilitated and the optical device 100 that can perform scanning with light can be realized.

Further, in the optical device 100 according to the present embodiment, when the length of the second region 15b is larger than the length of the first region 15a, it is possible to make the amount of the second light larger than the amount of the first light, and thus it is possible to increase the precision of optical scanning.

Further, in the optical device 100 according to the present embodiment, light that could not be extracted from the first region 15a can be moved away from the first region 15a by the second region 15b. Therefore, it is possible to reduce the possibility of allowing this light to exit as scattered light through the upper-portion structural body 100a. As a result, it is possible to reduce noise light.

### Modifications

### Positional Relationship Between Mirror 30, Mirror 40, and Liquid Crystal Layer 22

In the optical device 100 according to the present embodiment, as shown in FIG. 7A, a front end of the mirror 30 is positioned forward of a front end of the mirror 40 and forward of a front end of the liquid crystal layer 22. A rear end of the mirror 30 is positioned rearward of a rear end of the mirror 40 and rearward of a rear end of the liquid crystal layer 22. The front end of the mirror 40 is positioned forward of the front end of the liquid crystal layer 22. The rear end of the mirror 40 is positioned rearward of the rear end of the liquid crystal layer 22. In the example shown in FIG. 7A, the rear end and the front end of the liquid crystal layer 22 correspond to, respectively, the first end and the second end above. The terminal end of the second region 15b coincides with the second end.

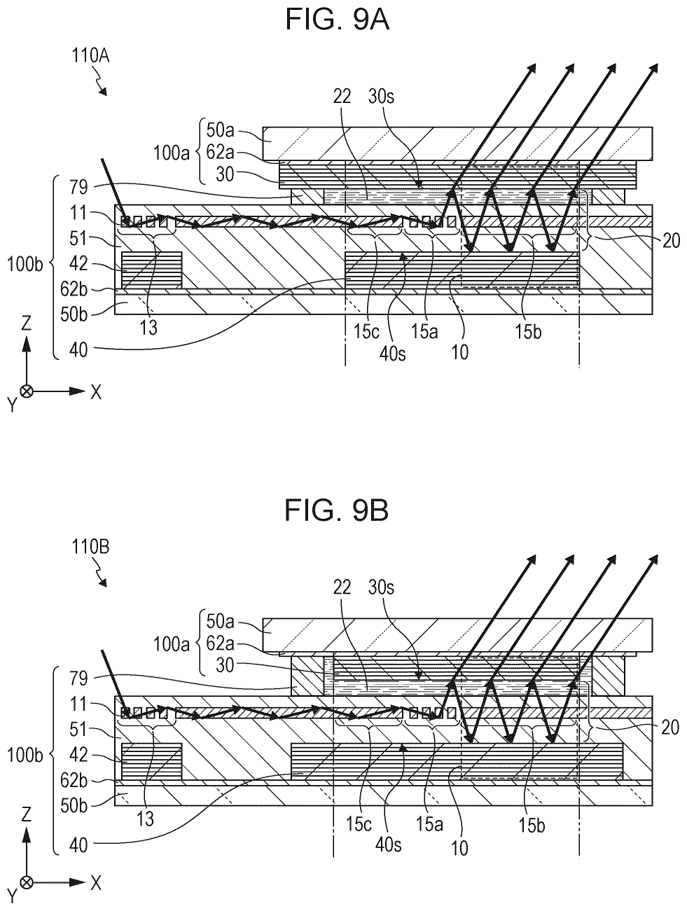

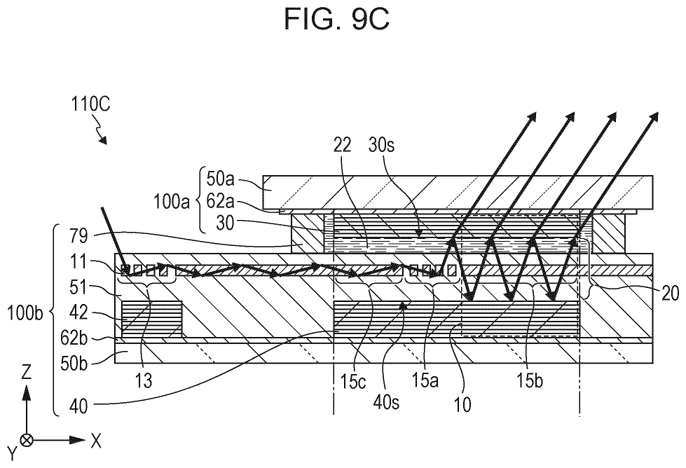

The positional relationship between the mirror 30, the mirror 40, and the liquid crystal layer 22 is not limited to the example above. With reference to FIGS. 9A to 9C, other examples of positional relationships between the mirror 30, the mirror 40, and the liquid crystal layer 22 are described below. FIGS. 9A to 9C are cross-sectional views parallel to an XZ plane, schematically showing Modifications 1 to 3 of the optical device 100 according to the present embodiment.

In an optical device 110A shown in FIG. 9A, unlike the optical device 100 shown in FIG. 7A, the front end of the mirror 40 is positioned rearward of the front end of the liquid crystal layer 22, and the rear end of the mirror 40 is positioned forward of the rear end of the liquid crystal layer 22. In the example shown in FIG. 9A, the rear end and the front end of the mirror 40 correspond to, respectively, the first end and the second end above. The terminal end of the second region 15b coincides with the second end.

In an optical device 110B shown in FIG. 9B, unlike the optical device 100 shown in FIG. 7A, not only the liquid crystal material, but also the mirror 30 is sealed by the seal member 79. Of a space that is filled with the liquid crystal material, a portion that is positioned between the mirror 30 and the mirror 40 corresponds to the liquid crystal layer 22. The front end of the mirror 30 is positioned rearward of the front end of the mirror 40 and is aligned with the front end of the liquid crystal layer 22. The rear end of the mirror 30 is positioned forward of the rear end of the mirror 40 and is aligned with the rear end of the liquid crystal layer 22. In the example shown in FIG. 9B, the rear end and the front end of the mirror 30 correspond to, respectively, the first end and the second end above. The terminal end of the second region 15b corresponds to the second end.

In an optical device 110C shown in FIG. 9C, unlike the optical device 110B shown in FIG. 9B, the front end of the mirror 40 is aligned with the front end of the mirror 30, and the rear end of the mirror 40 is aligned with the rear end of the mirror 30. In the example shown in FIG. 9C, the rear end and the front end of the mirror 30 correspond to, respectively, the first end and the second end above. The terminal end of the second region 15b is positioned rearward of the front end of the mirror 30. Therefore, the second region 15b does not reach the second end.

In the examples shown in FIGS. 9A to 9C, similarly to the example shown in FIG. 7A, the length of the second region 15b is larger than the length of the first region 15a. Therefore, as described above, it is possible to make the amount of the second light larger than the amount of the first light. As long as the length of the second region 15b is larger than the length of the first region 15a, the positional relationship between the mirror 30, the mirror 40, and the liquid crystal layer 22 is any positional relationship.

### Functions Added to Optical Waveguide 11

Light that could not be extracted from the first region 15a in each optical waveguide 11 returns by being reflected by the terminal end of each optical waveguide 11. When light that propagates through each optical waveguide 11 is to be extracted from the first region 15a, the returning light may give rise to light loss. When each optical waveguide 11 includes a portion that is positioned outside the second end, a function that reduces the returning light may be added to this portion.

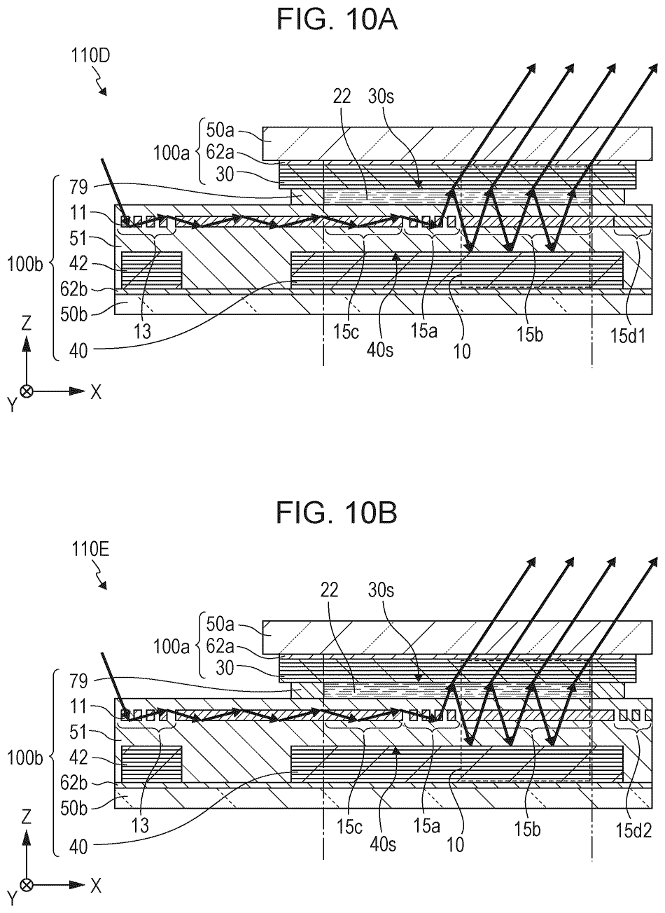

With reference to FIGS. 10A and 10B, examples of functions that are added to each optical waveguide 11 are described below. FIGS. 10A and 10B are cross-sectional views parallel to an XZ plane, schematically showing Modifications 4 and 5 of the optical device 100 according to the present embodiment.

In an optical device 110D shown in FIG. 10A, unlike the optical device 100 shown in FIG. 7A, each optical waveguide 11 includes at an outer side of the second end a fourth region 15d1 that causes light to be lost. The fourth region 15dl has, for example, a structure that diffuses light or a structure that absorbs light. Light that could not be extracted from the first region 15a in each optical waveguide 11 propagates through the second region 15b and is lost by the fourth region 15d1. Therefore, it is possible to reduce the returning light above.

In an optical device 110E shown in FIG. 10B, unlike the optical device 100 shown in FIG. 7A, each optical waveguide 11 includes at an outer side of the second end a fourth region 15d2 that extracts light that could not be extracted from the first region 15a. The fourth region 15d2 includes one or more gratings whose refractive index periodically changes along the X direction. The amount of light that is extracted from the fourth region 15d2 may correspond to the amount of the second light above that exits through the upper-portion structural body 100a. By detecting with a photodetector light that is extracted from the fourth region 15d2, it is possible to measure the amount of the second light or measure the efficiency with which light that is input to the light input region 13 is converted into the second light. If the light that could not be extracted from the first region 15a is effectively used, returning light is also reduced.

### Shape of First Region 15a and Shape of Second Region 15b

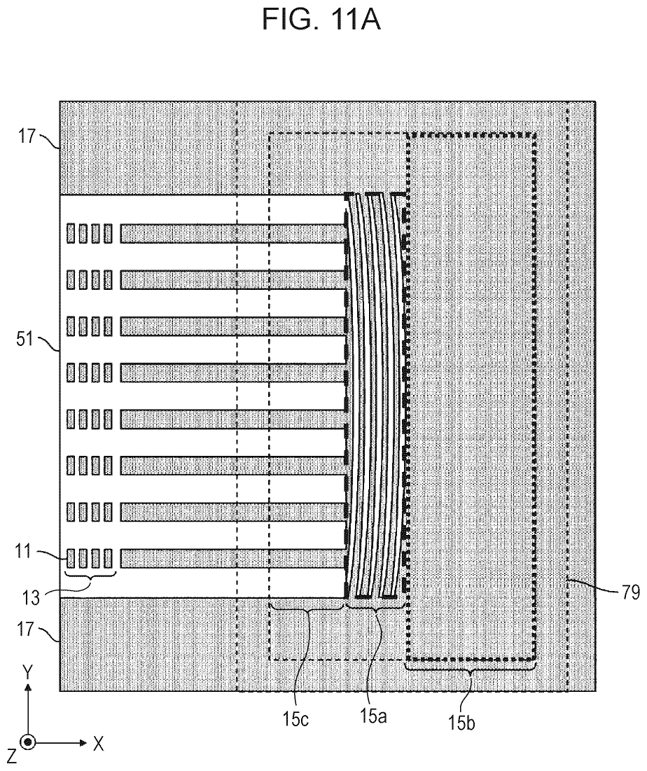

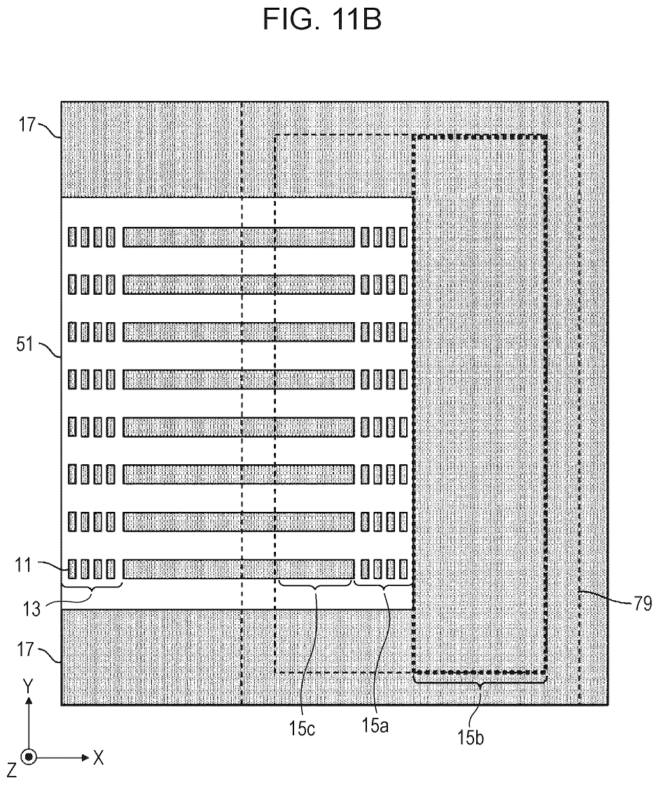

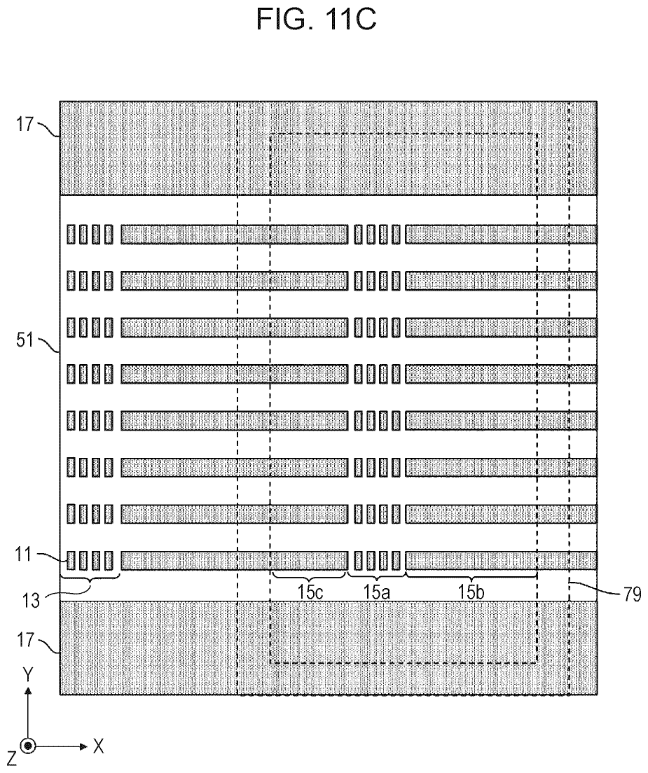

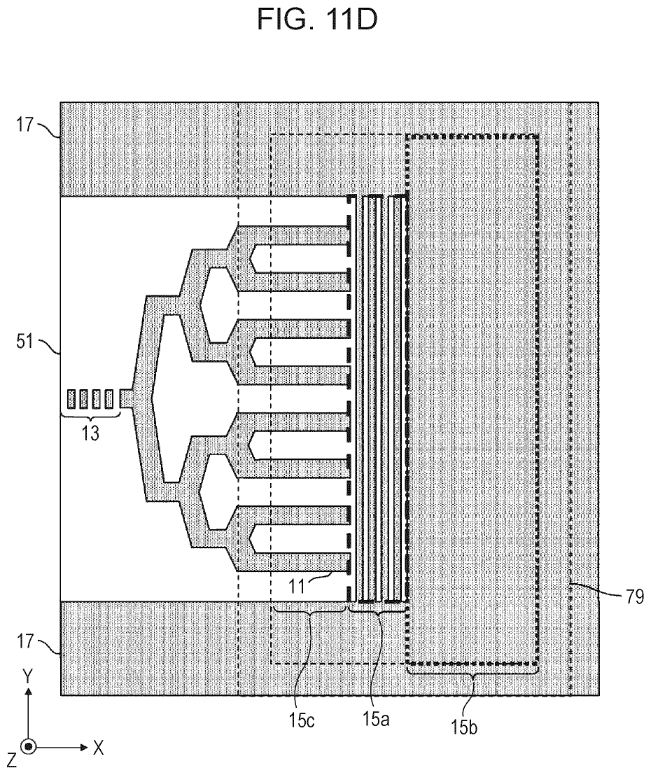

The shape of the first region 15a and the shape of the second region 15b are not limited to those of the example shown in FIG. 7C. With reference to FIGS. 11A to 11D, other examples of the shape of the first region 15a and the shape of the second region 15b are described. FIGS. 11A to 11D are cross-sectional views parallel to an XY plane of a layer including the optical waveguides 11 in Modifications 6 to 9 of the optical device 100 according to the present embodiment.

In a first region 15a shown in FIG. 11A, unlike the first region 15a shown in FIG. 7C, one or more gratings are formed by arc-shaped grooves instead of linear grooves. Therefore, light that is extracted from the first region 15a is easily formed into radially spreading light beams at the optical waveguide region 20 shown in FIGS. 7A and 7B. The radius of curvature of each arc-shaped groove may be, for example, greater than or equal to 0.3 mm and less than or equal to 0.8 mm. Due to the radially spreading light beams, it becomes easier to precisely change a component of exit light in the Y direction.

Unlike the first region 15a shown in FIG. 7C, first regions 15a shown in FIGS. 11B and 11C, and are each divided in correspondence with each optical waveguide 11. Unlike the second region 15b shown in FIG. 7C, a second region 15b shown in FIG. 11C is divided in correspondence with each optical waveguide 11.

As shown in FIGS. 11B and 11C, the first region 15a need not be a single region that is shared by the plurality of optical waveguides 11. Similarly, as shown in FIG. 11C, the second region 15b need not be a single region that is shared by the plurality of optical waveguides 11.

Unlike the plurality of optical waveguides 11 shown in FIG. 7C, the plurality of optical waveguides 11 shown in FIG. 11D branch off from one waveguide. This one waveguide includes a light input region 13. Light that is input from the light input region 13 branches off to be input to the plurality of optical waveguides 11. Therefore, the input of light to each optical waveguide 11 is facilitated. When, of the wave vector of light that exits through the upper-portion structural body 100a, a component parallel to the Y direction is to be changed, the optical waveguides 11 are formed so as to function as the phase shifters 80 shown in FIG. 5.

### Specific Examples of Materials and Dimensions of Structural Components

Specific examples of materials and dimensions of the structural components used in producing the optical device 100 according to the present embodiment and the modifications thereof are described below.

First, specific examples of materials and sizes of the structural components of the upper-portion structural body 100a are given.

The substrate 50a may be formed from, for example, an SiO₂ layer. The dimension of the substrate 50a in the X direction is, for example, greater than or equal to 5 mm and less than or equal to 10 mm, and the dimension of the substrate 50a in the Y direction may be, for example, greater than or equal to 5 mm and less than or equal to 20 mm. The substrate 50a may have a rectangular shape in which the dimension in the Y direction is larger than the dimension in the X direction. The thickness of the substrate 50a may be, for example, greater than or equal to 0.6 mm and less than or equal to 1.0 mm.

The electrode 62a may be formed from, for example, an ITO sputtering layer. The thickness of the electrode 62a may be, for example, greater than or equal to 50 nm and less than or equal to 150 nm.

The mirror 30 may be a multilayer reflection film. The multilayer reflection film may be formed by alternately depositing and stacking an Nb₂O₅ layer and an SiO₂ layer. The refractive index of the Nb₂O₅ layer is n=2.282, and the thickness of the Nb₂O₅ layer may be, for example, approximately 100 nm. The refractive index of the SiO₂ layer is n=1.468, and the thickness of the SiO₂ layer may be, for example, approximately 200 nm. The thickness of the mirror 30 may be, for example, greater than or equal to 1 μm and less than or equal to 10 μm. When the mirror 30 includes seven Nb₂O₅ layers and six SiO₂ layers, that is, a total of 13 layers, the thickness of the mirror 30 is approximately 1.9 μm.

Next, examples of materials and dimensions of the structural components of the lower-portion structural body 100b are given.

The substrate 50b may be formed from, for example, an SiO₂ layer. The dimension of the substrate 50b in the X direction is, for example, greater than or equal to 10 mm and less than or equal to 20 mm, and the dimension of the substrate 50b in the Y direction may be, for example, greater than or equal to 5 mm and less than or equal to 20 mm. The substrate 50b may have a substantially square shape. The thickness of the substrate 50b may be, for example, greater than or equal to 0.6 mm and less than or equal to 1.0 mm.

The electrode 62b may be formed from, for example, an ITO sputtering layer. The thickness of the electrode 62b may be, for example, greater than or equal to 50 nm and less than or equal to 150 nm.

The mirror 40 differs from the mirror 30 only in its thickness. The thickness of the mirror 40 may be, for example, greater than or equal to 1 μm and less than or equal to 10 μm. When the mirror 40 includes 31 Nb₂O₅ layers and 30 SiO₂ layers, that is, a total of 61 layers, the thickness of the mirror 40 is approximately 9.1 μm.

The dielectric layer 51 may be formed from, for example, an SiO₂ deposition layer. The refractive index of the SiO₂ deposition layer is n=1.468. Of the dielectric layer 51, the lower layer that supports the plurality of optical waveguides 11 may have a thickness that is, for example, greater than or equal to 0.5 μm and less than or equal to 2.0 μm. Of the dielectric layer 51, the upper layer that is provided on the plurality of optical waveguides 11 may have a thickness that is, for example, greater than or equal to 0.1 μm and less than or equal to 1.0 μm.

Each optical waveguide 11 may be formed from, for example, a Ta₂O₅ deposition layer. The refractive index of the Ta₂O₅ deposition layer is n=2.1. The thickness of each optical waveguide 11 may be, for example, greater than or equal to 100 nm and less than or equal to 500 nm. Each optical waveguide 11 may include a grating. A duty ratio of one or more gratings that are provided in the first region 15a is, for example, 1:1, and a pitch therebetween may be, for example, greater than or equal to 500 nm and less than or equal to 2000 nm. This also applies to a duty ratio of and a pitch between the one or more gratings that are provided in the first region 15a. The one or more gratings may be formed by patterning based on a photolithography method. Of each optical waveguide 11, a portion that is positioned rearward of the first region 15a may have a width that is, for example, greater than or equal to 0.5 μm and less than or equal to 10 μm.

In order to form the plurality of optical waveguides 11 and the non-waveguide regions 17 as shown in FIG. 7C, the other dielectric layer that is provided on the lower layer above may be removed by, for example, patterning based on a photolithography method.

For the liquid crystal material that is included in the liquid crystal layer 22, for example, a 5CB liquid crystal may be used. As an orientation film material, for example, polyimide may be used. The thickness of the polyimide orientation film is, for example, approximately 80 nm.

For the seal member 79, for example, an ultraviolet curable adhesive 3026E manufactured by ThreeBond Co., Ltd. may be used. By, for example, ultraviolet radiation having a wavelength of 365 nm and an energy density of 100 mJ/cm², the seal member 79 is cured to affix the upper-portion structural body 100a and the lower-portion structural body 100b to each other.

It should be noted that the substrates 50a and 50b may be made of materials other than SiO₂. The substrates 50a and 50b may each be, for example, an inorganic substrate, such as a glass or a sapphire substrate, or a resin substrate, such as an acrylic substrate or a polycarbonate substrate. Since these inorganic substrates and the resin substrates are light-transmissive, they can be used as the substrates 50a and 50b.

The reflectance of each of the mirrors 30 and 40 may be, for example, 90%. The reflectance of each of the mirrors 30 and 40 may be even higher and may be greater than or equal to 99%. The reflectance of the mirror 30 from which light exits is, for example, 99.9%, and the reflectance of the mirror 40 from which light does not exit may be, for example, 99.99%.

The reflectance of each of the mirrors 30 and 40 can be realized by adjusting the number of layers of the multilayer reflection film. When two layers in the multilayer reflection film are combined, for example, the refractive index of one of the layers is greater than or equal to 2, and the refractive index of the other layer is less than 2. If the difference between the two refractive indices is large, it is possible to obtain a high reflectance. The layer whose refractive index is greater than or equal to 2 is made of, for example, at least one selected from the group consisting of SiNₓ, AlNₓ, TiOₓ, ZrOₓ (1.7≤x≤2.0), NbO_{y}, and TaO_{y} (2.2≤y≤2.5). The layer whose refractive index is less than 2 is made of, for example, at least one selected from the group consisting of SiOₓ and AlOₓ. The refractive index of the dielectric layer 51 may be, for example, less than 2. The refractive index of each optical waveguide 11 may be, for example, greater than or equal to 2. If the difference between the two refractive indices is sufficiently large, it is possible to reduce evanescent light that seeps out to the dielectric layer 51 from each optical waveguide 11.

### APPLICATION EXAMPLES

### Examples of Application to Optical Scanning Device

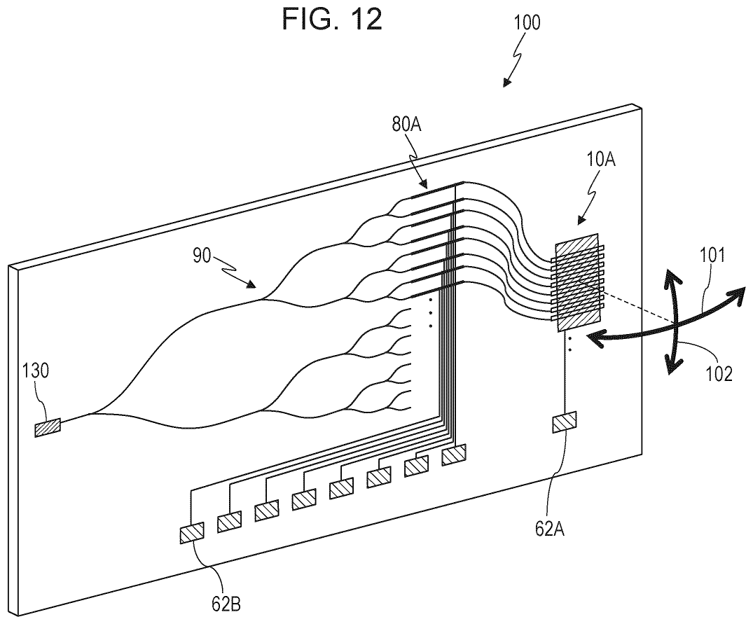

FIG. 12 shows an example of a structure of an optical scanning device 100 in which an optical divider 90, a waveguide array 10A, a phase shifter array 80A, and an element, such as a light source 130, are integrated on a circuit board (for example, a chip). As the optical scanning device 100, the optical device according to the present embodiment and the modifications thereof may be used. The light source 130 may be, for example, a light emitting element such as a semiconductor laser element. The light source 130 in this example emits light having a single wavelength at which a wavelength in free space is 2. The optical divider 90 divides light from the light source 130 to introduce the divided light into waveguides at a plurality of phase shifters. In the example shown in FIG. 12, an electrode 62A and a plurality of electrodes 62B are provided on the chip. A control signal is supplied to the waveguide array 10A from the electrode 62A. Control signals are supplied to a plurality of phase shifters 80 of the phase shifter array 80A from the plurality of electrodes 62B. The electrode 62A and the plurality of electrodes 62B may be connected to a control circuit (not shown) that generates the control signals above. The control circuit may be provided on the chip shown in FIG. 12 or another chip of the optical scanning device 100.

As shown in FIG. 12, optical scanning of a wide range can be realized by a small device by integrating all of the components on the chip. It is possible to integrate all of the components shown in FIG. 12 on, for example, a chip having a size of approximately 2 mm×1 mm.

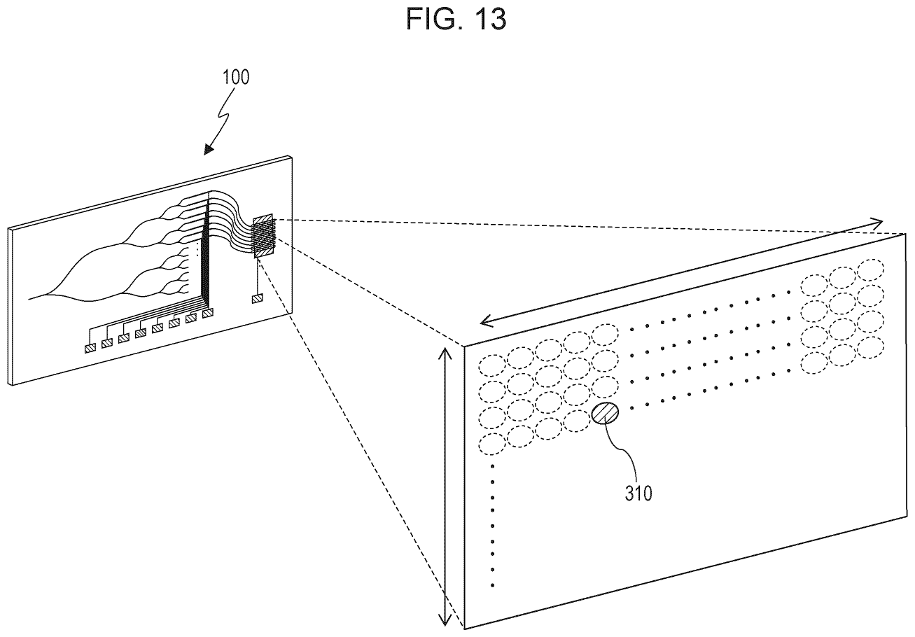

FIG. 13 is a schematic view showing a state in which two-dimensional scanning is performed by applying a light beam, such as a laser light beam, to a distant location from the optical scanning device 100. The two-dimensional scanning is performed by moving a beam spot 310 in a horizontal direction and a vertical direction. For example, by combining with a publicly known TOF (Time Of Flight) method, it is possible to obtain a two-dimensional ranging image. The TOF method is a method of, by irradiating an object with laser light and observing reflection light from the object, calculating a flight time of the light and determining the distance.

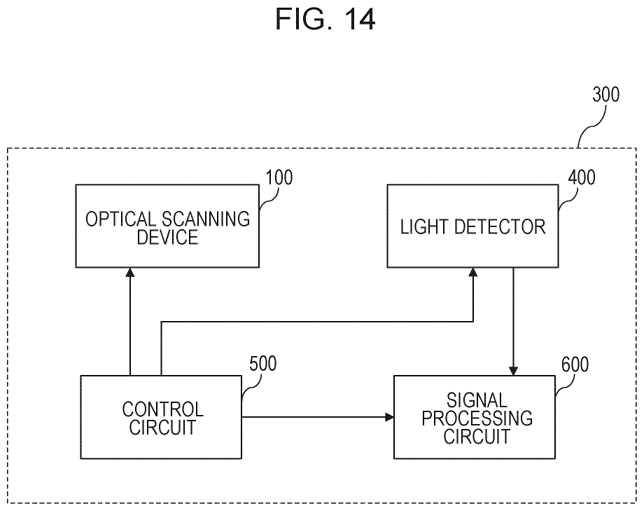

FIG. 14 is a block diagram showing an example of a structure of a LiDAR system 300 that is an example of a light detection system that can produce such a ranging image. The LiDAR system 300 includes an optical scanning device 100, a light detector 400, a signal processing circuit 600, and a control circuit 500. The light detector 400 detects light that exits from the optical scanning device 100 and that is reflected by an object. The light detector 400 may be, for example, an image sensor that has sensitivity to a wavelength λ of light that exits from the optical scanning device 100 or a photodetector that includes an optical receiving element, such as a photodiode. The light detector 400 outputs an electrical signal corresponding to the amount of received light. On the basis of the electrical signal output from the light detector 400, the signal processing circuit 600 calculates the distance up to an object and produces distance distribution data. The distance distribution data is data that indicates a two-dimensional distribution of the distance (such as a ranging image). The control circuit 500 is a processor that controls the optical scanning device 100, the light detector 400, and the signal processing circuit 600. The control circuit 500 controls the timing of irradiation with a light beam from the optical scanning device 100 and the timing of exposure and signal readout of the light detector 400, and instructs the signal processing circuit 600 to generate a ranging image.

In two-dimensional scanning, a frame rate of obtaining a ranging image can be selected from, for example, 60 fps, 50 fps, 30 fps, 25 fps, and 24 fps, which are generally frequently used in videos. When application to a vehicle-mounted system is considered, as the frame rate increases, the frequency of obtaining a ranging image is increased, as a result of which it is possible to precisely detect an obstacle. For example, when traveling at 60 km/h, at a frame rate of 60 fps, it is possible to obtain an image each time a car moves by approximately 28 cm. At a frame rate of 120 fps, it is possible to obtain an image each time the car moves by approximately 14 cm. At a frame rate of 180 fps, it is possible to obtain an image each time the car moves by approximately 9.3 cm.

The time required for obtaining one ranging image depends upon the speed of beam scanning. For example, in order to obtain at 60 fps an image whose resolution is 100×100, it is necessary to perform beam scanning at 1.67 us or less for every one point. In this case, the control circuit 500 controls, at an operating speed of 600 kHz, exiting of a light beam from the optical scanning device 100 and a signal accumulation/readout by the light detector 400.

### Examples of Application to Optical Receiving Device

The optical device according to the present embodiment and the modifications thereof have substantially the same structures, and can each be used as an optical receiving device. The optical receiving device includes a waveguide array 10A that is the same as that of the optical scanning device, and a first adjustment element that adjusts a direction of light that can be received. Each first mirror 30 of the waveguide array 10A transmits therethrough light that is incident upon a side opposite to a reflection surface 30s from the third direction. Each optical waveguide layer 20 of the waveguide array 10A causes the light transmitted through the first mirror 30 to propagate in the first direction. When the first adjustment element changes at least one of the refractive index, the thickness, and the wavelength of light of the optical waveguide layer 20 of each waveguide element 10, it is possible to change the direction of light that can be taken in and received by each optical waveguide layer 20. Further, it is possible to two-dimensionally change the direction of light that can be received when the optical receiving device includes a plurality of phase shafters 80, which are the same as those of the optical scanning device, and a second adjustment element that changes differences between the phases of light output from the plurality of waveguide elements 10 through the plurality of phase shifters 80. It is possible to suppress a reduction in the intensity of received light by using the optical device according to the present embodiment and the modifications thereof as the optical receiving device.

For example, it is possible to form an optical receiving device in which the light source 130 of the optical scanning device 100 shown in FIG. 12 is replaced by a receiving circuit. When light having a wavelength λ is incident upon the waveguide array 10A, the light is sent to the optical divider 90 through the phase shifter array 80A, is finally gathered at one location, and is sent to the receiving circuit. It can be said that the intensity of light that is gathered at one location represents the sensitivity of the optical receiving device. The sensitivity of the optical receiving device can be adjusted by adjustment elements that are separately incorporated in the waveguide array and the phase shifter array 80A. In the optical receiving device, for example, in FIG. 4, the direction of the wave vector (thick arrow in the figure) is in the opposite direction. The incident light includes a light component in a direction of extension of each waveguide element 10 (the X direction in the figure) and a light component in a direction of arrangement of the waveguide elements 10 (the Y direction in the figure). The sensitivity of the light component in the X direction can be adjusted by the adjustment element incorporated in the waveguide array 10A. On the other hand, the sensitivity of the light component in the direction of arrangement of the waveguide elements 10 can be adjusted by the adjustment element incorporated in the phase shifter array 80A. From a phase difference Δp of light when the sensitivity of the optical receiving device becomes a maximum, and a refractive index n_{w} and a thickness d of each optical waveguide layer 20, θ and do shown in FIG. 4 can be known. This makes it possible to determine an incidence direction of the light.

### Appendix

The following technologies are disclosed by the description of the embodiments above.

### Technology 1

An optical device comprising:
a first mirror;
a second mirror that is disposed to face the first mirror;
an adjustment layer that is positioned between the first mirror and the second mirror, and whose refractive index or thickness is adjustable; and
an optical waveguide configured to propagate light along a predetermined direction and including a portion positioned between the first mirror and the second mirror,
wherein the portion of the optical waveguide positioned between the first mirror and the second mirror includes a first region, a second region that is positioned on a side opposite to a light input side of the first region, and a third region that is positioned on a side opposite to the second region with the first region being interposed between the second region and the third region,
wherein the first region includes one or more gratings whose refractive index periodically changes along the predetermined direction,
wherein the second region and the third region do not include a grating, and
wherein, in top view, the first region, the second region, and the third region overlap all of the first mirror, the second mirror, and the adjustment layer.

The optical device can be easily manufactured and can perform scanning with light.

### Technology 2

The optical device according to technology 1,
wherein a dimension of the second region in the predetermined direction is larger than a dimension of the first region in the predetermined direction.

Due to the optical device, the amount of light used in optical scanning can be larger than the amount of noise light.

### Technology 3

The optical device according to technology 2,
wherein a length of the second region in the predetermined direction is greater than or equal to 150 μm.

Due to the optical device, a spot diameter of exit light can be approximately 30 cm at a distance 100 m away.

### Technology 4

The optical device according to any one of technologies 1 to 3,
wherein, in top view, in a region where all of the first mirror, the second mirror, and the adjustment layer overlap each other, a first end is defined as an end closer to the first region in the predetermined direction and a second end is defined as an end closer to the second region in the predetermined direction, and
wherein the portion of the optical waveguide positioned between the first mirror and the second mirror extends from the first end to the second end.

Due to the optical device, light that could not be extracted from the first region can be moved away from the first region by the second region and can exit to an outer side of an optical waveguide region through the second region.

### Technology 5

The optical device according to technology 4,
wherein the optical waveguide includes a fourth region positioned outside the second end, the fourth region configured to attenuate the light.

Due to the optical device, it is possible to reduce the possibility of causing light that could not be extracted from the first region to become returning light.

### Technology 6

The optical device according to technology 4,
wherein the optical waveguide includes a fourth region positioned outside the second end, the fourth region having one or more additional gratings.

Due to the optical device, light that could not be extracted from the first region can be extracted from the fourth region and can be effectively used.

### Technology 7

The optical device according to any one of technologies 1 to 6,
wherein the predetermined direction is a first direction,
wherein each of the first mirror and the second mirror has a shape extending along a plane parallel to both the first direction and a second direction intersecting the first direction, and
wherein the optical device includes a plurality of optical waveguides that are disposed along the second direction, the plurality of optical waveguides including the optical waveguide.

Due to the optical device, of a wave vector of exit light, a component in the second direction can be changed.

### Technology 8

The optical device according to technology 7,
wherein the first region is a single region that is shared by the plurality of optical waveguides,
wherein the second region is a single region that is shared by the plurality of optical waveguides, and
wherein a width of the second region in the second direction is larger than a width of the first region in the second direction.

Due to the optical device, it becomes easier for a radially spreading light beam to propagate in the second region.

### Technology 9

The optical device according to technology 8,
wherein the one or more gratings in the first region are formed by an arc-shaped groove.

Due to the optical device, it becomes easier for a radially spreading light beam to be formed in the second region.

### Technology 10

The optical device according to any one of technologies 1 to 9,
wherein the adjustment layer includes a liquid crystal material or an electro-optical material

Due to the optical device, it is possible to change the refractive index of the adjustment layer and, of the wave vector of exit light, change a component in the predetermined direction.

The optical device of the embodiments of the present disclosure can be used in, for example, a rider system that is mounted on a vehicle, such as an automobile, a UAV, or an AGV.

What is claimed is:

1. An optical device comprising:
a first mirror;
a second mirror that is disposed to face the first mirror;
an adjustment layer that is positioned between the first mirror and the second mirror, and whose refractive index or thickness is adjustable; and
an optical waveguide configured to propagate light along a predetermined direction and including a portion positioned between the first mirror and the second mirror,
wherein the portion of the optical waveguide positioned between the first mirror and the second mirror includes a first region, a second region that is positioned on a side opposite to a light input side of the first region, and a third region that is positioned on a side opposite to the second region with the first region being interposed between the second region and the third region,
wherein the first region includes one or more gratings whose refractive index periodically changes along the predetermined direction,
wherein the second region and the third region do not include a grating, and
wherein, in top view, the first region, the second region, and the third region overlap all of the first mirror, the second mirror, and the adjustment layer.

2. The optical device according to claim 1,
wherein a dimension of the second region in the predetermined direction is larger than a dimension of the first region in the predetermined direction.

3. The optical device according to claim 2,
wherein a length of the second region in the predetermined direction is greater than or equal to 150 μm.

4. The optical device according to claim 1,
wherein, in top view, in a region where all of the first mirror, the second mirror, and the adjustment layer overlap each other, a first end is defined as an end closer to the first region in the predetermined direction and a second end is defined as an end closer to the second region in the predetermined direction, and
wherein the portion of the optical waveguide positioned between the first mirror and the second mirror extends from the first end to the second end.

5. The optical device according to claim 4,
wherein the optical waveguide includes a fourth region positioned outside the second end, the fourth region configured to attenuate the light.

6. The optical device according to claim 4,
wherein the optical waveguide includes a fourth region positioned outside the second end, the fourth region having one or more additional gratings.

7. The optical device according to claim 1,
wherein the predetermined direction is a first direction,
wherein each of the first mirror and the second mirror has a shape extending along a plane parallel to both the first direction and a second direction intersecting the first direction, and
wherein the optical device includes a plurality of optical waveguides that are disposed along the second direction, the plurality of optical waveguides including the optical waveguide.

8. The optical device according to claim 7,
wherein the first region is a single region that is shared by the plurality of optical waveguides,
wherein the second region is a single region that is shared by the plurality of optical waveguides, and
wherein a width of the second region in the second direction is larger than a width of the first region in the second direction.

9. The optical device according to claim 8,
wherein the one or more gratings in the first region are formed by an arc-shaped groove.

10. The optical device according to claim 1,
wherein the adjustment layer includes a liquid crystal material or an electro-optical material.
